(19) United States
(12) Patent Application Publication
(10) Pub. No.: US 2024/0166784 A1
(43) Pub. Date: May 23, 2024

(54) POLYMER LATEX COMPOSITION

(71) Applicant: Synthomer Sdn. Bhd., Johor Darul Takzim (MY)

(72) Inventors: Zhenli Wei, Johor Darul Takzim (MY); Yi-Fan Goh, Johor Darul Takzim (MY); Chi Hoong Chan, Johor Darul Takzim (MY)

(73) Assignee: Synthomer Sdn. Bhd., Johor Darul Takzim (MY)

(21) Appl. No.: 18/281,705

(22) PCT Filed: Mar. 8, 2022
(86) PCT No.: PCT/MY2022/050015

§ 371 Date: Sep. 12, 2023

(30) Foreign Application Priority Data
Mar. 19, 2021 (MY) PI 2021001494

(51) Int. Cl. C08F 212/10; B29C 41/00; B29C 41/14; B29C 41/22; B29C 41/46; B29K 105/00; C08K 5/5435; C08K 5/548; C09D 5/02; C09D 7/63; C09D 125/14

(52) U.S. Cl. CPC C08F 212/10; B29C 41/003; B29C 41/14; B29C 41/22; B29C 41/46; C08K 5/5435; C08K 5/548; C09D 5/022; C09D 7/63; C09D 125/14; B29K 2105/0064; B29K 2105/0085; C08F 2800/20; C08K 2201/014

(57) ABSTRACT

The present invention relates to a polymer latex composition, to a method for the preparation of such a polymer latex composition, to the use of said polymer latex composition for the production of elastomeric articles, to a compounded latex composition comprising said polymer latex composition, to a method for making dip-molded articles, to a method for making elastomeric articles and to articles made by using said polymer latex composition.

The present invention relates to a polymer latex composition, to a method for the preparation of such polymer latex composition, to the use of said polymer latex composition for the production of elastomeric articles, to a compounded latex composition comprising said polymer latex composition, to a method for making dip-molded articles, to a method for making elastomeric articles and to articles made by using said polymer latex composition.

### BACKGROUND OF THE INVENTION

In the art of making articles based on a polymer latex it is in general desired to achieve a high tensile strength and at the same time high elongation of the film forming the article to provide high mechanical strength and desired softness to the article. This is particularly important for gloves such as surgical gloves. Furthermore, in the recent past it was discovered that a growing number of persons show allergic reactions to latex based articles, for example a natural rubber latex that has been used commonly in the past in the manufacturing of latex products such as dip molded product containing up to 5% of non-rubber components such as proteins, lipids and trace elements. Users of natural rubber latex products have developed Type-I hypersensitivity which is caused by the residual extractable latex proteins present in natural rubber products.

Natural as well as artificially made polymer latices are commonly crosslinked using a sulfur vulcanization system including sulfur and sulfur-containing accelerators. The use of these sulfur vulcanization systems in rubber gloves manufacturing can give rise to the delay Type-IV hypersensitivity such as allergic contact dermatitis.

As a result, it is desirable to avoid sulfur vulcanization systems and particularly to provide polymer latices that can be used for the manufacture of dip-molded articles that do not need the standard sulfur vulcanization systems including the sulfur-containing accelerators previously used therein in order to obtain the desired mechanical properties of the final product.

It is further the object of the present invention to provide a polymer latex composition that results in softer films, while maintaining the advantageous properties of the polymer latex such as good tensile properties.

Another object is to provide a polymer latex composition that has increased pot life, while maintaining the advantageous properties of the polymer latex to achieve a high tensile strength and at the same time high elongation of the film forming the article.

Moreover, it is an object of the present invention to provide good durability of the polymer latex.

### SUMMARY OF THE INVENTION

The following clauses summarize some aspects of the present invention.

According to a first aspect, the present invention relates to a polymer latex composition for the preparation of elastomeric film comprising:
(I) particles of a latex polymer obtained by free-radical emulsion polymerization of a composition comprising ethylenically unsaturated monomers, the latex polymer comprising (I-a) a functional group; and
(II) a silane compound comprising (II-a) at least two terminal silane functional groups and (II-b) a thermally reversible bond; or
(III) a silane compound comprising (III-a) one terminal silane functional group and (III-b) at least one additional functional group capable to form a thermally reversible bond (III-c) with the functional group (I-a) of the latex polymer (I).

The polymer latex composition may have a thermally reversible bond (II-b) or (III-c) which is capable of disrupting and rearranging at a temperature of or less than 200° C.

The thermally reversible bond (II-b) or (III-c) may be selected from the group consisting of disulfide, tetrasulfide, carbonate, urea, thiourea, ester, beta-hydroxy ester, thioester, beta-hydroxy amine, beta-hydroxy thioether, amide, urethane, enamine, imine, hemiacetal, acetal, hemiketal, ketal, boronate ester, siloxane, oxime, acylhydrazone, aldol, thiuram disulfide and trithiocarbonate.

Preferably, the silane compound (II) may have the structural formula:

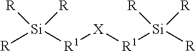

wherein X is the thermally reversible bond (II-b), preferably selected from the group comprising disulfide, tetrasulfide, carbonate, urea, thiourea, ester, beta-hydroxy ester, thioester, beta-hydroxy amine, beta-hydroxy thioether, amide, urethane, enamine, imine, hemiacetal, acetal, hemiketal, ketal, boronate ester, siloxane, oxime, acylhydrazone, aldol, thiuram disulfide and trithiocarbonate; R is independently selected from hydrogen, halogen, hydroxyl, alkoxy, hydrocarbyl, silane or mixtures thereof; and R¹ independently is a linear or a branched C₁-C₂₀ alkanediyl, cyclic C₃-C₂₀ alkyl or alkenyl, or arylenediyl, preferably a linear C₁-C₂₀ alkanediyl.

Moreover, the silane compound (II) may be formed in situ from (IV) a first silane compound comprising (IV-a) one terminal silane functional group and (IV-b) at least one additional functional group capable to form a thermally reversible bond (IV-c) with an additional functional group (IV-b) of a second silane compound (IV).

The at least one additional functional group (III-b) of the silane compound (III) or the at least one additional functional group (IV-b) of the first silane compound (IV) and/or the at least one additional functional group (IV-b) of the second silane compound (IV) may be blocked.

The silane compound (II) preferably may be selected from the group consisting of bis[3-(trialkoxysilylpropyl)] disulfide, bis[3-(trialkxysilyl)propyl] tetrasulfide, bis[3-(trialkoxysilyl)propyl] carbonate, N,N′-bis[3-(trialkoxysilyl)propyl] urea, N,N′-bis[3-(trialkoxysilyl)propyl] thiourea, 2-hydroxy-3-[3-(trialkoxysilyl)propoxy]propyl 3-(trihydroxysilyl)propanoate, 2-hydroxy-7-(trialkoxysilyl)heptyl 3-(trihydroxysilyl)propanoate, 9,9-dialkoxy-1,1,1-trihydroxy-10-oxa-5-thia-1,9-disiladodecan-4-one, N-[3-(trialkoxysilyl)propyl]-3-(trihydroxysilyl)propenamide, (trialkoxysilyl)methyl N-[3-(trialkoxysilyl)propyl]carbamate, (7E)-4,4,12,12-tetraalkoxy-3,13-dioxa-8-aza-4,12-disilapentadec-7-ene, 4,4,11,11-tetraalkoxy-3,6,12-trioxa-4,11-disilatetradecan-7-ol, 4,4,10,10-tetraalkoxy-7-[3-(trialkoxysilyl)propyl]-3,6,8,11-tetraoxa-4,10-disilatridecane, oligomeric siloxanes, and combinations thereof.

The silane compound (III) or the silane compound (IV) may have the structural formula:

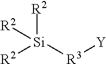

wherein R² is independently selected from hydrogen, halogen, hydroxyl, alkoxy, hydrocarbyl or mixtures thereof; R³ is linear or branched C₁-C₂₀ alkanediyl, cyclic C₃-C₂₀ alkyl or alkenyl, or arylenediyl, preferably linear C₁-C₂₀ alkanediyl; and Y is the functional group (III-b) or (IV-b), preferably selected from the group consisting of epoxy, thiol, hydroxy, hydroxylamine, primary or secondary amino, isocyanato, oxazolino, aziridino, imino, carbodiimido, glycol, ester, acetoxy, carboxyl acid, dioxolanone, hydrazido, aldehyde, ketone and combinations thereof.

The silane compound (III) or the silane compound (IV) may be selected from the group consisting of (3-glycidyloxypropyl) trialkoxysilane, beta-(3,4-epoxycyclohexylethyl trialkoxysilane), dialkoxy (3-glycidyloxypropyl)alkylsilane, 3-glycidoxypropyldialkylalkoxysilane, 5,6-epoxyhexyltrialkoxysilane, amino propyl trialkoxysilane, hydroxymethyltrialkoxysilane, 3-mercaptopropyltrialkoxysilane, 3-chloropropyltrialkoxysilane, vinyltrialkoxysilane, 3-(trialkoxysilyl)furan, norbonenyltrialkoxysilane, carboxyethyl silanetriol, 3-isocyanatopropyltrialkoxysilane, tris[3-(trialkoxysilyl)propyl] isocyanurate, trialkoxysilyl butyraldehyde, ureidopropyltrialkoxysilane, cyanomethyl [3-(trialkoxysilyl)propyl] trithiocarbonate, S-(octanoyl) mercaptopropyl trialkoxysilane, and combinations thereof.

Preferably, the particles of a latex polymer (I) may be present in amounts of 80 to 99.9 wt.-%, preferably 85 to 99.9 wt.-%, more preferred 90 to 99.9 wt.-%, even more preferred 92 to 99.8 wt.-% and most preferred 95 to 99.8 wt.-% and the silane compound (II) may be present in amounts of 0.1 to 20 wt.-%, preferably 0.1 to 15 wt.-%, more preferred 0.1 to 10 wt.-%, even more preferred 0.2 to 8 wt.-%, most preferred 0.2 to 5 wt.-%, or the silane compound (III) may be present in amounts of 0.1 to 20 wt.-%, preferably 0.1 to 18 wt.-%, more preferred 0.1 to 15 wt.-%, even more preferred 0.1 to 12 wt.-%, most preferred 0.1 to 10 wt.-% based on the total weight of the particles of a latex polymer (I) and the silane compound (II) or the silane compound (III).

The functional groups (I-a) of the particles of the latex polymer (I) may be selected from the group consisting of carbon-carbon double bond, carboxylic acid, hydroxy, epoxy, acetoacetyl, primary or secondary amino, acetoxy, isocyanato, alkoxy, dioxolanone, halide functional group, thiol, hydroxylamine, oxazolino, aziridino, imino, carbodiimido, glycol, ester, hydrazido, aldehyde, ketone and combinations thereof.

The polymer latex composition comprising the silane compound (II) may further comprise a silane compound (V), wherein the silane compound (V) comprises (V-a) one terminal silane functional group and (V-b) at least one additional functional group reactive with the functional group (I-a) of the latex polymer (I).

The functional group (V-b) of the silane compound (V) may preferably be selected from the group consisting of carbon-carbon double bond, halide functional group, epoxy, thiol, hydroxy, hydroxylamine, primary or secondary amino, isocyanato, oxazolino, aziridino, imino, carbodiimido, glycol, ester, acetoxy, carboxyl acid, dioxolanone, hydrazido, aldehyde, ketone and combinations thereof.

The silane compound (V) may have the structural formula:

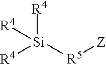

wherein R⁴ is independently selected from hydrogen, halogen, hydroxyl, alkoxy, hydrocarbyl or mixtures thereof; R⁵ is linear or branched C₁-C₂₀ alkanediyl, cyclic C₃-C₂₀ alkyl or alkenyl, or arylenediyl, preferably linear C₁-C₂₀ alkanediyl; and Z is the functional group (V-b) reactive with the functional groups (I-a) of the particles of the latex polymer (I), wherein the functional group (V-b) preferably is selected from the group consisting of carbon-carbon double bond, halide functional group, epoxy, thiol, hydroxy, hydroxylamine, primary or secondary amino, isocyanato, oxazolino, aziridino, imino, carbodiimido, glycol, ester, acetoxy, carboxyl acid, dioxolanone, hydrazido, aldehyde, ketone, and combinations thereof.

Preferably, the silane compound (V) may be selected from the group consisting of (3-glycidyloxypropyl) trialkoxysilane, beta-(3,4-epoxycyclohexylethyl trialkoxysilane), dialkoxy (3-glycidyloxypropyl)alkylsilane, 3-glycidoxypropyldialkylalkoxysilane, 5,6-epoxyhexyltrialkoxysilane, amino propyl trialkoxysilane, hydroxymethyltrialkoxysilane, 3-mercaptopropyltrialkoxysilane, 3-chloropropyltrialkoxysilane, vinyltrialkoxysilane, 3-(trialkoxysilyl)furan, norbonenyltrialkoxysilane, carboxyethyl silanetriol, 3-isocyanatopropyltrialkoxysilane, tris[3-(trialkoxysilyl)propyl] isocyanurate, trialkoxysilyl butyraldehyde, ureidopropyltrialkoxysilane, cyanomethyl [3-(trialkoxysilyl)propyl] trithiocarbonate, S-(octanoyl) mercaptopropyl trialkoxysilane, and combinations thereof.

The particles of a latex polymer (I) may be present in amounts of 80 to 99.8 wt.-%, preferably 85 to 99.8 wt.-%, more preferred 90 to 99.5 wt.-%, even more preferred 92 to 99.5 wt.-% and most preferred 95 to 99.2 wt.-%; the silane compound (II) may be present in amounts of 0.1 to 20 wt.-%, preferably 0.1 to 15 wt.-%, more preferred 0.1 to 10 wt.-%, even more preferred 0.2 to 8 wt.-%, most preferred 0.2 to 5 wt.-%; and the silane compound (V) may be present in amounts of 0.1 to 20 wt.-%, preferably 0.1 to 15 wt.-%, more preferred 0.1 to 10 wt.-%, even more preferred 0.2 to 8 wt.-%, most preferred 0.2 to 5 wt.-%; based on the total weight of the particles of a latex polymer (I), the silane compound (II), and the silane compound (V).

Preferably, the mass ratio of the silane compound (II) to the silane compound (V) may be from 100:1 to 1:100, preferably from 80:1 to 1:80, more preferred 50:1 to 1:50, even more preferred from 20:1 to 1:20, most preferred 10:1 to 1:10.

The monomer composition to obtain the particles of a latex polymer (I) may comprise:
(i) 15 to 99 wt.-% of conjugated dienes;
(ii) 1 to 80 wt.-% of monomers selected from ethylenically unsaturated nitrile compounds;
(iii) 0 to 10 wt.-% of an ethylenically unsaturated compound different from (i) and (ii) comprising a functional group (a);
(iv) 0 to 80 wt.-% of vinyl aromatic monomers; and
(v) 0 to 65 wt.-% of alkyl esters of ethylenically unsaturated acids;
the weight percentages being based on the total weight of monomers in the monomer composition.

It is envisaged that
(i) the conjugated dienes of the polymer latex composition may be selected from butadiene, isoprene, 2,3-dimethyl-1,3-butadiene, 2-ethyl-1,3-butadiene, 1,3-pentadiene and combinations thereof;
(ii) the ethylenically unsaturated nitrile compounds of the polymer latex composition may be selected from (meth)acrylonitrile, alpha-cyanoethyl acrylonitrile, fumaronitrile, alpha-chloronitrile and combinations thereof;
(iii) the ethylenically unsaturated compounds different from (i) and (ii) comprising a functional group (a) of the polymer latex composition may be selected from
(iii1) ethylenically unsaturated compounds having at least two different ethylenically unsaturated groups, preferably selected from allyl(meth)acrylate, vinyl(meth)acrylate, and combinations thereof;
(iii2) ethylenically unsaturated acids and salts thereof preferably selected from (meth)acrylic acid, crotonic acid, itaconic acid, maleic acid, fumaric acid, ethylenically unsaturated sulfonic acids, ethylenically unsaturated phosphorous containing acids and salts thereof, polycarboxylic acid anhydride, polycarboxylic acid partial ester monomer, carboxy alkyl esters of ethylenically unsaturated acids, and combinations thereof;
(iii3) hydroxy functional ethylenically unsaturated compounds preferably selected from allyl alcohol, vinyl alcohol, N-methylolacrylamide, 1-penten-3-ol, hydroxyalkyl esters of ethylenically unsaturated acids, and combinations thereof;
(iii4) oxirane functional ethylenically unsaturated compounds, preferably selected from glycidyl methacrylate, allyl glycidylether, vinyl glycidylether, vinyl cyclohexene oxide, limonene oxide, 2-ethylglycidyl (meth)acrylate, 2-(n-propyl)glycidyl (meth)acrylate, 2-(n-butyl)glycidyl (meth)acrylate, glycidyl (meth)acrylate, (3′,4′-epoxyheptyl)-2-ethyl (meth)acrylate, (6′,7′-epoxyheptyl)(meth)acrylate, allyl-3,4-epoxyheptylether, 6,7-epoxyheptylallylether, vinyl-3,4-epoxyheptylether, 3,4-epoxyheptylvinylether, 6,7-epoxyheptylvinylether, o-vinylbenzylglycidylether, m-vinylbenzylglycidylether, p-vinylbenzylglycidylether, 3-vinyl cyclohexene oxide, alpha-methyl glycidyl methacrylate, 3,4-epoxycyclohexylmethyl (meth)acrylate, 3,4-epoxy-1-butene, 1,2-epoxy-5-hexene, 4-vinyl-1-cyclohexene 1,2-epoxide, 2-methyl-2-vinyloxirane, 3,4-epoxy-1-cyclohexene, glycidyl propargyl ether, and combinations thereof;
(iii5) acetoacetyl functional ethylenically unsaturated compounds, preferably acetoacetoxyethyl (meth)acrylate, acetoacetoxypropyl (meth)acrylate, allyl acetoacetate, acetoacetoxybutyl (meth)acrylate, 2,3-di(acetoacetoxy)propyl (meth)acrylate, acetoacetoxy(methyl)ethyl (meth)acrylate, acetoacetamido-ethyl(meth)acrylate, 3-(methacryloyloxy)-2,2-dimethylpropyl 3-oxobutanoate, 3-(methacryloyloxy)-2,2,4,4-tetramethylcyclobutyl 3-oxobutanoate, 3-(methacryloyloxy)-2,2,4-trimethylpentyl 3-oxobutanoate, 1-(methacryloyloxy)-2,2,4-trimethylpentan-3-yl 3-oxobutanoate, (4-(methacryloyloxymethyl)cyclohexyl)methyl 3-oxobutanoate, and combinations thereof;
(iii6) ethylenically unsaturated compounds bearing a primary or secondary amino group, preferably selected from (meth)acrylamide, 2-amino ethyl (meth)acrylate hydrochloride, 2-amino ethyl (meth) acrylamide hydrochloride, N-ethyl (meth)acrylamide, N-(3-amino propyl) (meth)acrylamide hydrochloride, N-hydroxyethyl (meth)acrylamide, N-3-(dimethylamino) propyl (meth)acrylamide, [3-(methacryloylamino)propyl] trimethylammonium, N-[tris(hydroxymethyl) methyl](meth)acrylamide, N-phenylacrylamide, alkylacrylamide, methacrylamide poly(ethylene glycol) amine hydrochloride, and combinations thereof;
(iii7) acetoxy functional ethylenically unsaturated compounds, preferably 1-acetoxy-1,3-butadiene, diacetoneacrylamide, and combinations thereof;
(iii8) isocyanato functional ethylenically unsaturated compounds, preferably 2-isocyanate ethyl (meth)acrylate, allyl isocyanate, 3-isopropenyl-α,α-dimethylbenzyl isocyanate, and combinations thereof;
(iii9) alkoxysilyl functional ethylenically unsaturated compounds, preferably allyl trimethoxysilane, allyl triethoxysilane, vinyl trimethoxysilane, vinyl triethoxy silane, 3-butenyltriethoxysilane, 3-(trimethoxysilyl)propyl (meth)acrylate, 5-hexenyltriethoxysilane, styrylethyltrimethoxysilane, trimethoxy(7-octen-1-yl)silane, 11-allyloxyundecyltrimethoxysilane, allylphenylpropyltriethoxysilane, [(5-bicyclo[2.2.1]hept-2-enyl)ethyl]trimethoxysilane, (5-bicyclo[2.2.1]hept-2-enyl)triethoxysilane, n-allyl-aza-2,2-dimethoxysilacyclopentane norbornenyltriethoxysilane, [2-(3-cyclohexenyl)ethyl]triethoxysilane, and combinations thereof;
(iii10) alkoxy functional ethylenically unsaturated compounds, preferably 2-methoxy ethyl (meth)acrylate, 2-ethoxy ethyl (meth)acrylate, methyl-3-methoxy(meth)acrylate, and combinations thereof;
(iii11) dioxolanone functional ethylenically unsaturated compounds, preferably glycerol carbonate methacrylate, 4-vinyl-1,3-dioxolan-2-one, and combinations thereof;
(iii12) halide functional ethylenically unsaturated compounds, preferably vinyl chloride, allyl chloride, 2-chloro-1,3-butadiene, 2-chloroethyl acrylate, 3-chloro-2-hydroxypropyl methacrylate, methyl 2-(chloromethyl) (meth)acrylate, 2,3-dichloropropyl (meth)acrylate, 2,3-dibromopropyl (meth)acrylate, and combinations thereof;
(iii13) thiol functional ethylenically unsaturated compounds, preferably allyl mercaptan, N-acryloyl-cysteamine, and combinations thereof;
(iii14) hydroxylamine functional ethylenically unsaturated compounds, preferably acrylohydroxamic acid;
(iii15) oxazolino functional ethylenically unsaturated compounds, preferably oxazoline substituted acrylic ester;
(iii16) aziridino functional ethylenically unsaturated compounds, preferably 2-(aziridine-1-yl)ethyl acrylate;
(iii17) imino functional ethylenically unsaturated compounds, preferably 2-[(2-methylprop-2-enoyl)oxy]ethyl (3E)-3-(alkylimino)butanoate;
(iii18) carbodiimino functional ethylenically unsaturated compounds, preferably N-α,α′-dimethyl isopropenyl benzyl-N′-cyclohexyl carbodiimide, N-α,α′-dimethyl isopropenyl benzyl-N′-butyl carbodiimide, and combinations thereof;
(iii19) glycol functional ethylenically unsaturated compounds, preferably ethylene glycol methyl ether (meth)acrylate, ethylene glycol phenyl ether (meth)acrylate, di(ethylene glycol) methyl ether (meth)acrylate, tri(ethylene glycol) methyl ether (meth)acrylate, poly(ethylene glycol) methyl ether (meth)acrylate, poly(ethylene glycol) phenyl ether acrylate, poly(ethylene glycol) (meth)acrylate, poly(propylene glycol) (meth)acrylate poly(ethylene glycol)-block-poly(propylene glycol)-block-poly(ethylene glycol) (meth)acrylate, polyglycol partial ester monomer, and combinations thereof;
(iii20) hydrazido functional ethylenically unsaturated compounds, preferably 2-propenoic acid hydrazide, methacryloyl hydrazide, and combinations thereof;
(iii21) aldehyde functional ethylenically unsaturated compounds, preferably (meth)acrolein, 2-ethylacrolein, 3-methyl-2-butenal, tiglic aldehyde, crotonaldehyde, 3-methylcrotonaldehyde, 2-pentenal, 2-methyl-2-pentenal, 4-pentenal or 2,2-dimethyl-4-pentenal, 2,4-heptadienal, and combinations thereof;
(iii22) ketone functional ethylenically unsaturated compounds, preferably 1-penten-3-one, 3-buten-2-one, 4-methoxy-3-buten-2-one, 3-penten-2-one, 2-cyclopent-1-one, 2-cyclohexen-1-one, and combinations thereof;
and combinations thereof;
(iv) the vinyl aromatic monomers of the polymer latex composition may be selected from styrene, alpha-methyl styrene and combinations thereof;
(v) alkyl esters of ethylenically unsaturated acids of the polymer latex composition may be selected from methyl (meth)acrylate, ethyl (meth)acrylate, propyl (meth)acrylate, butyl (meth)acrylate, 2-ethylhexyl (meth)acrylate, and combinations thereof;
and combinations thereof;
the mixture of ethylenically unsaturated monomers for latex polymer (I) may optionally comprise ethylenically unsaturated monomers selected from
(vi) vinyl carboxylates, preferably vinyl acetate;
(vii) monomers having at least two identical ethylenically unsaturated groups, preferably selected from divinyl benzene, ethylene glycol dimethacrylate, glycerol dimethacrylate and 1,4 butanediol di(meth)acrylate, and combinations thereof; and combinations thereof.

It is envisaged that
the functional groups (I-a) may be selected from groups having a carbon-carbon double bond and the functional groups (V-b) may be selected from groups having carbon-carbon double bonds and thiol; or
the functional groups (I-a) may be selected from carboxylic acid functional groups and the functional groups (V-b) may be selected from epoxy, thiol, hydroxy, primary or secondary amino, isocyanato, oxazolino, aziridino, imino, carbodiimido, glycol groups, ester groups, and acetoxy; or
the functional groups (I-a) may be selected from hydroxyl and the functional groups (V-b) may be selected from alkoxysilyl, carboxylic acid functional groups; isocyanato, primary or secondary amino, aldehyde, boronic acid and ester groups; or
the functional groups (I-a) may be selected from epoxy and the functional groups (V-b) may be selected from carboxylic acid functional groups, hydroxyl and ester groups; or
the functional groups (I-a) may be selected from acetoacetyl and the functional groups (V-b) may be selected from groups having carbon-carbon double bonds, isocyanato, aldehyde, hydrazide, hydrazine and primary or secondary amino; or
the functional groups (I-a) may be selected from primary or secondary amino and the functional groups (V-b) may be selected from carboxylic acid functional groups, epoxy, ester groups and dioxolanone groups; or
the functional groups (I-a) may be selected from acetoxy and the functional groups (V-b) may be selected from hydrazido and primary or secondary amino; or
the functional groups (I-a) may be selected from isocyanato and the functional groups (V-b) may be selected from carboxylic acid functional groups. hydroxyl, primary or secondary amino and thiol; or
the functional groups (I-a) may be selected from alkoxysilyl and the functional groups (V-b) may be selected from hydroxyl and alkoxysilyl; or
the functional groups (I-a) may be selected from alkoxy and the functional groups or (V-b) may be selected from ester groups; or
the functional groups (I-a) may be selected from ester groups and the functional groups (V-b) may be selected from hydroxyl, carboxylic acid groups and ester groups;
the functional groups (I-a) may be selected from dioxolanone groups and the functional groups (V-b) may be selected from primary or secondary amino;
the functional groups (I-a) may be selected from halide functional groups and the functional groups (V-b) may be selected from carboxylic acids;
the functional groups (I-a) may be selected from thiol functional groups and the functional groups (V-b) may be selected from carbon-carbon double bond, carboxylic acid functional groups, and isocyanato;
the functional groups (I-a) may be selected from hydroxylamine and the functional groups (V-b) may be selected from aldehyde;
the functional groups (I-a) may be selected from oxazolino and the functional groups (V-b) may be selected from carboxylic acid;
the functional groups (I-a) may be selected from aziridino and the functional groups (V-b) may be selected from carboxylic acid and hydroxyl;
the functional groups (I-a) may be selected from imino and the functional groups (V-b) may be selected from carboxylic acid;
the functional groups (I-a) may be selected from carbodiimino and the functional groups (V-b) may be selected from carboxylic acid;
the functional groups (I-a) may be selected from glycol groups and the functional groups (V-b) may be selected from carboxylic acid functional groups;
the functional groups (I-a) may be selected from hydrazido and the functional groups (V-b) may be selected from aldehyde;
the functional groups (I-a) may be selected from aldehyde and the functional groups (V-b) may be selected from hydroxyl, acetoacetyl, hydroxylamine, and hydrazido;
the functional groups (I-a) may be selected from ketone and the functional groups (V-b) may be selected from hydroxy.

Preferably, the bond formed by the reaction of the functional groups (I-a) and the functional groups (V-b) is thermally reversible.

A further aspect of the invention relates to a method for preparation of a polymer latex composition comprising:
(A) polymerizing in an emulsion polymerization process a composition comprising ethylenically unsaturated monomers for latex polymer (I) comprising at least one monomer resulting after polymerization in a functional group (I-a) to obtain a latex comprising particles of latex polymer (I) comprising functional groups (I-a); and
(B1) adding a silane compound (II) comprising at least two terminal silane functional groups (II-a) and a thermally reversible bond (II-b); or
(B2) adding a silane compound (III) comprising (III-a) one terminal silane functional group and (III-b) at least one additional functional group capable to form a thermally reversible bond (III-c) with the functional group (I-a) of the latex polymer (I).

Preferably, the method for preparation of a polymer latex composition comprises:
(B1) adding a compound (II) comprising at least two terminal silane functional groups (II-a) and a thermally reversible bond (II-b); and
(C) optionally adding a compound (V) comprising one terminal silane functional group (V-a) and at least one additional functional group (V-b) reactive with the functional groups (I-a) of the particles of the latex polymer (I).

Moreover, another aspect of the invention relates to use of the polymer latex composition for the production of elastomeric articles or for coating or impregnating a substrate.

In addition, according to a further aspect, the invention relates to a compounded polymer latex composition suitable for the production of dip-molded articles comprising the polymer latex composition as discussed and optionally adjuvants selected from sulfur vulcanization agents, accelerators for vulcanization, free-radical initiators, pigments, and combinations thereof.

Preferably, the compounded latex composition may be free of sulfur vulcanization agents and accelerators for sulfur vulcanization and optionally comprising polyvalent cations and/or silica-based fillers.

The compounded latex composition may comprise the polyvalent cations present in amounts up to 20 wt.-%, based on the total weight of the particles of a latex polymer (I), the silane compound (II) or the silane compound (III), and optionally the silane compound (V).

Another aspect of the present invention relates to a method for making dip-molded articles by
(a) providing a compounded latex composition as described;
(b) immersing a mold having the desired shape of the final article in a coagulant bath comprising a solution of a metal salt;
(c) removing the mold from the coagulant bath and optionally drying the mold;
(d) immersing the mold as treated in step b) and c) in the compounded latex composition of step a);
(e) coagulating a latex film on the surface of the mold;
(f) removing the latex-coated mold from the compounded latex composition and optionally immersing the latex-coated mold in a water bath;
(g) optionally drying the latex-coated mold;
(h) heat treating the latex-coated mold obtained from step e) or f) at a temperature of 40° C. to 180° C.; and/or exposing the latex-coated mold obtained from step e) or f) to UV radiation;
(i) removing the latex article from the mold.

Furthermore, according to another aspect the invention relates to a method for making elastomeric articles comprising:
(a) obtaining a continuous elastomeric film from the polymer latex composition as described;
(b) optionally heat treating the continuous elastomeric film and/or exposing the continuous elastomeric film to UV radiation;
(c) aligning two separate continuous elastomeric films;
(d) cutting or stamping the aligned continuous elastomeric films into a preselected shape to obtain two superposed layers of the elastomeric films in the preselected shape;
(e) joining together the superposed layers at least in a preselected part of the periphery to form an elastomeric article.

The joining together may be performed by using thermal means, preferably selected from heat sealing and welding or by gluing or a combination of thermal means and gluing.

Another aspect of the invention relates to an article made by using the polymer latex composition as described.

The article may be selected from surgical gloves, examination gloves, condoms, catheters, industrial gloves, textile-supported gloves, household gloves balloons, tubing, dental dam, apron and pre-formed gasket.

### DETAILED DESCRIPTION OF THE INVENTION

The present invention relates to a polymer latex composition comprising:
(I) particles of a latex polymer obtained by free-radical emulsion polymerization of a composition comprising ethylenically unsaturated monomers, the latex polymer comprising (I-a) a functional group; and
(II) a silane compound comprising (II-a) at least two terminal silane functional groups and (II-b) a thermally reversible bond; or
(III) a silane compound comprising (III-a) one terminal silane functional group and (III-b) at least one additional functional group capable to form a thermally reversible bond (III-c) with the functional group (I-a) of the latex polymer (I).

The polymer latex composition is suitable for the preparation of elastomeric film. As used herein, the term “thermally reversible bond” refers to a chemical link between two functional groups that results from a temperature-dependent equilibrium-based chemical reaction wherein the chemical link forms at low temperatures, but is reversibly driven to disruption and rearrangement as the temperature is increased. According to the present invention, the thermally reversible bond may be formed at a temperature of or less than 200° C., preferably of or less than 180° C., more preferably of or less than 160° C. Typically, the thermally reversible bond may be formed at a temperature range of 25 to 200° C. According to the present invention, the thermally reversible bond is capable to disrupt at a temperature of or less than 200° C., preferably of or less than 190° C., more preferably of or less than 180° C. and rearrange to form a thermally reversible bond. Typically, the thermally reversible bond may be capable to disrupt and rearrange at a temperature range of from 25 to 200° C.

### Latex Polymer (I) Comprising a Functional Group (I-a)

The latex polymer (I) to be used according to the present invention can be prepared by any suitable free-radical emulsion polymerization process known in the art. Suitable process parameters are those that will be discussed below.

The unsaturated monomers to be used for the preparation of the latex polymer (I) and their relative amounts are not particularly critical as long as the monomer mixture comprises at least one ethylenically unsaturated monomer that provides for a functional group (I-a) on the latex polymer (I). Monomer compositions comprising conjugated dienes and ethylenically unsaturated nitrile compounds are particularly useful, e.g., for dip-molding applications.

Suitable functional groups (I-a) of the particles of the latex polymer (I) may be selected from the group consisting of carbon-carbon double bond, carboxylic acid, hydroxy, epoxy, acetoacetyl, primary or secondary amino, acetoxy, isocyanato, alkoxy, dioxolanone, halide functional group, thiol, hydroxylamine, oxazolino, aziridino, imino, carbodiimido, glycol, ester, hydrazido, aldehyde, ketone, and combinations thereof.

According to the present invention, the monomer composition to obtain the particles of a latex polymer (I) may comprise:
(i) 15 to 99 wt.-% of conjugated dienes;
(ii) 1 to 80 wt.-% of monomers selected from ethylenically unsaturated nitrile compounds;
(iii) 0 to 10 wt.-% of an ethylenically unsaturated compound different from (i) and (ii) comprising a functional group (a);
(iv) 0 to 80 wt.-% of vinyl aromatic monomers; and
(v) 0 to 65 wt.-% of alkyl esters of ethylenically unsaturated acids;
the weight percentages being based on the total weight of monomers in the monomer composition.

Conjugated diene monomers suitable for the preparation of latex polymer (I) according to the present invention may include conjugated diene monomers selected from 1,3-butadiene, isoprene, 2,3-dimethyl-1,3-butadiene, 2,3-dimethyl-1,3-butadiene, 2-chloro-1,3-butadiene, 1,3-pentadiene, 1,3-hexadiene, 2,4-hexadiene, 1,3-octadiene, 2-methyl-1,3-pentadiene, 2,3-dimethyl-1,3-pentadiene, 3,4-dimethyl-1,3-hexadiene, 2,3-diethyl-1,3-butadiene, 4,5-diethyl-1,3-octadiene, 3-butyl-1,3-octadiene, 3,7-dimethyl-1,3,6-octatriene, 2-methyl-6-methylene-1,7-octadiene, 7-methyl-3-methylene-1,6-octadiene, 1,3,7-octatriene, 2-ethyl-1,3-butadiene, 2-amyl-1,3-butadiene, 3,7-dimethyl-1,3,7-octatriene, 3,7-dimethyl-1,3,6-octatriene, 3,7,11-trimethyl-1,3,6,10-dodecatetraene, 7,11-dimethyl-3-methylene-1,6,10-dodecatriene, 2,6-dimethyl-2,4,6-octatriene, 2-phenyl-1,3-butadiene, 2-methyl-3-isopropyl-1,3-butadiene and 1,3-cyclohexadiene and combinations thereof, preferably 1,3-butadiene, isoprene, 2,3-dimethyl-1,3-butadiene, 2-ethyl-1,3-butadiene, 1,3-pentadiene, and combinations thereof. 1,3-Butadiene, isoprene and combinations thereof are the more preferred conjugated dienes. 1,3-Butadiene is the most preferred diene. Typically, the amount of conjugated diene monomer ranges from 15 to 99 wt.-%, preferably from 20 to 95 wt.-%, more preferably from 30 to 75 wt.-%, most preferably from 40 to 70 wt.-%, based on the total weight of monomers. Thus, the conjugated diene may be present in amounts of at least 15 wt.-%, at least 20 wt.-%, at least 22 wt.-%, at least 24 wt.-%, at least 26 wt.-%, at least 28 wt.-%, at least 30 wt.-%, at least 32 wt.-%, at least 34 wt.-%, at least 36 wt.-%, at least 38 wt.-%, or at least 40 wt.-%, based on the total weight of the ethylenically unsaturated monomers for the latex polymer (I). Accordingly, the conjugated diene monomers can be used in amounts of no more than 99 wt.-%, no more than 95 wt.-%, no more than 90 wt.-%, no more than 85 wt.-%, no more than 80 wt.-%, no more than 78 wt.-%, no more than 76 wt.-%, no more than 74 wt.-%, no more than 72 wt.-%, no more than 70 wt.-%, no more than 68 wt.-%, no more than 66 wt.-%, no more than 64 wt.-%, no more than 62 wt.-%, no more than 60 wt.-%, no more than 58 wt.-%, or no more than 56 wt.-%. A person skilled in the art will appreciate that any range between any of the explicitly disclosed lower and upper limit is herein disclosed.

Unsaturated nitrile monomers which can be used in the present invention may include polymerizable unsaturated aliphatic nitrile monomers which contain from 2 to 4 carbon atoms in a linear or branched arrangement, which may be substituted either by acetyl or additional nitrile groups. The ethylenically unsaturated nitrile compounds for the preparation of latex polymer (I) according to the present invention may be selected from acrylonitrile, methacrylonitrile, alpha-cyanoethyl acrylonitrile, fumaronitrile, alpha-chloronitrile and combinations thereof, with acrylonitrile being most preferred. These nitrile monomers can be included in amounts from 1 to 80 wt.-%, preferably from 10 to 70 wt.-%, or 1 to 60 wt.-%, and more preferred from 15 to 50 wt.-%, even more preferred from 20 to 50 wt.-%, most preferred from 23 to 43 wt.-%, based on the total weight of ethylenically unsaturated monomers for the latex polymer (I).

Thus, the unsaturated nitrile may be present in amounts of at least 1 wt.-%, at least 5 wt.-%, at least 10 wt.-%, at least 12 wt.-%, at least 14 wt.-%, at least 16 wt.-%, at least 18 wt.-%, at least 20 wt.-%, at least 22 wt.-%, at least 24 wt.-%, at least 26 wt.-%, at least 28 wt.-%, at least 30 wt.-%, at least 32 wt.-%, at least 34 wt.-%, at least 36 wt.-%, at least 38 wt.-%, or at least 40 wt.-%, based on the total weight of the ethylenically unsaturated monomers for the latex polymer (I). Accordingly, the unsaturated nitrile monomers can be used in amounts of no more than 80 wt.-%, no more than 75 wt.-%, no more than 73 wt.-%, no more than 70 wt.-%, no more than 68 wt.-%, no more than 66 wt.-%, no more than 64 wt.-%, no more than 62 wt.-%, no more than 60 wt.-%, no more than 58 wt.-%, no more than 56 wt.-%, no more than 54 wt.-%, no more than 52 wt.-%, no more than 50 wt.-%, no more than 48 wt.-%, no more than 46 wt.-%, or no more than 44 wt.-%. A person skilled in the art will appreciate that any range between any of the explicitly disclosed lower and upper limit is herein disclosed.

The ethylenically unsaturated compounds different from (i) and (ii) comprising a functional group (a) suitable for the preparation of latex polymer (I) according to the present invention may be selected from:
(iii1) ethylenically unsaturated compounds having at least two different ethylenically unsaturated groups;
(iii2) ethylenically unsaturated acids and salts thereof;
(iii3) hydroxy functional ethylenically unsaturated compounds;
(iii4) oxirane functional ethylenically unsaturated compounds;
(iii5) acetoacetyl functional ethylenically unsaturated compounds;
(iii6) ethylenically unsaturated compounds bearing a primary or secondary amino group;
(iii7) acetoxy functional ethylenically unsaturated compounds;
(iii8) isocyanato functional ethylenically unsaturated compounds;
(iii9) alkoxysilyl functional ethylenically unsaturated compounds;
(iii10) alkoxy functional ethylenically unsaturated compounds;
(iii11) dioxolanone functional ethylenically unsaturated compounds;
(iii12) halide functional ethylenically unsaturated compounds;
(iii13) thiol functional ethylenically unsaturated compounds;
(iii14) hydroxylamine functional ethylenically unsaturated compounds;
(iii15) oxazolino functional ethylenically unsaturated compounds;
(iii16) aziridino functional ethylenically unsaturated compounds;
(iii17) imino functional ethylenically unsaturated compounds;
(iii18) carbodiimino functional ethylenically unsaturated compounds;
(iii19) glycol functional ethylenically unsaturated compounds;
(iii20) hydrazido functional ethylenically unsaturated compounds;
(iii21) aldehyde functional ethylenically unsaturated compounds;
(iii22) ketone functional ethylenically unsaturated compounds;
and combinations thereof.

Suitable ethylenically unsaturated compounds (iii1) having at least two different ethylenically unsaturated groups may be selected from allyl(meth)acrylate, vinyl(meth)acrylate, and combinations thereof.

Suitable ethylenically unsaturated acids and salts thereof (iii2) may be selected from ethylenically unsaturated carboxylic acid monomers, ethylenically unsaturated sulfonic acid monomers, ethylenically unsaturated phosphorous-containing acid monomers. The ethylenically unsaturated carboxylic acid monomers suitable for use in the present invention include monocarboxylic acid and dicarboxylic acid monomers, monoesters of dicarboxylic acid and carboxy alkyl esters of ethylenically unsaturated acids such as 2-carboxy ethyl (meth)acrylate. Carrying out the present invention, it is preferable to use ethylenically unsaturated aliphatic mono- or dicarboxylic acids or anhydrides which contain from 3 to 5 carbon atoms. Examples of monocarboxylic acid monomers include (meth)acrylic acid, crotonic acid and examples of dicarboxylic acid monomers including fumaric acid, itaconic acid, maleic acid and maleic anhydride. Examples of other suitable ethylenically unsaturated acids include vinyl acetic acid, vinyl lactic acid, vinyl sulfonic acid, 2-methyl-2-propene-1-sulfonic acid, styrene sulfonic acid, acrylamidomethyl propane sulfonic acid and the salts thereof. (Meth)acrylic acid, crotonic acid, itaconic acid, maleic acid, fumaric acid, ethylenically unsaturated sulfonic acids, ethylenically unsaturated phosphorous containing acids and salts thereof, polycarboxylic acid anhydride, polycarboxylic acid partial ester monomer, carboxylic alkyl esters of ethylenically unsaturated acids and combinations thereof are particularly preferred.

Examples of ethylenically unsaturated sulfonic acid monomers include vinylsulfonic acid, phenyl vinylsulfonate, sodium 4-vinylbenzenesulfonate, 2-methyl-2-propene-1-sulfonic acid, 4-styrenesulfonic acid, 3-allyloxy-2-hydroxy-1-propanesulfonic acid, 2-acrylamido-2-methyl-1-propanesulfonic acid and the salts thereof.

Examples of ethylenically unsaturated phosphorus-containing acid monomers include vinylphosphonic acid, dimethyl vinylphosphonate, diethyl vinylphosphonate, diethyl allylphosphonate, allylphosphonic acid and the salts thereof.

Suitable hydroxy functional ethylenically unsaturated compounds (iii3) may be selected from allyl alcohol, vinyl alcohol, N-methylolacrylamide, 1-penten-3-ol, hydroxyalkyl esters of ethylenically unsaturated acids and combinations thereof. Hydroxyalkyl esters of ethylenically unsaturated acids include hydroxy alkyl(meth)acrylate monomers, such as hydroxyethyl (meth)acrylate, hydroxypropyl (meth)acrylate, hydroxybutyl (meth)acrylate, glycerol (meth)acrylate, 2-hydroxypropyl maleate, and glycerol undecenoate.

Suitable oxirane-functional ethylenically unsaturated monomers (iii4) may be selected from glycidyl (meth)acrylate, allyl glycidylether, vinyl glycidylether, vinyl cyclohexene oxide, limonene oxide, 2-ethylglycidyl(meth)acrylate, 2-(n-propyl)glycidyl(meth)acrylate, 2-(n-butyl)glycidyl(meth)acrylate, glycidyl (meth)acrylate, (3′,4′-epoxyheptyl)-2-ethylacrylate, (3′,4′-epoxyheptyl)-2-ethyl(meth)acrylate, (6′,7′-epoxyheptyl)(meth)acrylate, allyl-3,4-epoxyheptylether, 6,7-epoxyheptylallylether, vinyl-3,4-epoxyheptylether, 3,4-epoxyheptylvinylether, 6,7-epoxyheptylvinylether, o-vinylbenzylglycidylether, m-vinylbenzylglycidylether, p-vinylbenzylglycidylether, 3-vinyl cyclohexene oxide, alpha-methyl glycidyl methacrylate, 3,4-epoxycyclohexylmethyl (meth)acrylate, 3-4-epoxy-1-butene, 1,2-epoxy-5-hexene, 4-vinyl-1-cyclohexene 1,2-epoxide, 2-methyl-2-vinyloxirane, 3,4-epoxy-1-cyclohexene, glycidyl propargyl ether, and combinations thereof. Glycidyl (meth)acrylate is particularly preferred.

Suitable acetoacetyl functional ethylenically unsaturated compounds (iii5) may be selected from acetoacetoxyethyl (meth)acrylate, acetoacetoxypropyl (meth)acrylate, allyl acetoacetate, acetoacetoxybutyl (meth)acrylate, 2,3-di(acetoacetoxy)propyl (meth)acrylate, acetoacetoxy(methyl)ethyl (meth)acrylate, acetoacetamido-ethyl(methyl)acrylate, (2-acetoacetamido-2-methylpropyl) (meth)acrylate, 3-(methacryloyloxy)-2,2-dimethylpropyl 3-oxobutanoate, 3-(methacryloyloxy)-2,2,4,4-tetramethylcyclobutyl 3-oxobutanoate, 3-(methacryloyloxy)-2,2,4-trimethylpentyl 3-oxobutanoate, I-((meth)acryloyloxy)-2,2,4-trimethylpentan-3-yl 3-oxobutanoate, (4-((meth)acryloyloxymethyl)cyclohexyl)methyl 3-oxobutanoate, and combinations thereof.

Ethylenically unsaturated compounds bearing a primary or secondary amino group (iii6) suitable for the preparation of latex polymer (I) according to the present invention may be selected from (meth)acrylamide, alkyl(meth)acrylamides for example N-ethyl(meth)acrylamide, N-tert-butyl(meth)acrylamide, N-phenyl(meth)acrylamide, N-(isobutoxymethyl)(meth)acrylamide, N-propyl(meth)acrylamide, aminoalkyl esters of ethylenically unsaturated acids, for example 2-amino ethyl (meth)acrylate hydrochloride, N-(3-aminopropyl) (meth)acrylamide hydrochloride, 2-amino ethyl (meth)acrylamide hydrochloride, (2-(N-tert-butoxycarbonylamino)ethyl (meth)acrylate, and N-3-(dimethylamino)propyl(meth)acrylamide. The ethylenically unsaturated compounds bearing a primary or secondary amino group (iii6) preferably may be selected from (meth)acrylamide, 2-amino ethyl (meth)acrylate hydrochloride, 2-amino ethyl (meth)acrylamide hydrochloride, N-ethyl(meth)acrylamide, N-(3-aminopropyl) (meth)acrylamide hydrochloride, N-hydroxyethyl (meth)acrylamide, N-3-(dimethylamino)propyl(meth)acrylamide, [3-(methacryloylamino)propyl]trimethylammonium, N-[tris(hydroxymethyl) methyl] (meth)acrylamide, N-phenylacrylamide, alkylacrylamide, methacrylamide poly(ethylene glycol) amine hydrochloride and combinations thereof. Suitable acetoxy functional ethylenically unsaturated compounds (iii7) may be selected from 1-acetoxy-1,3-butadiene, diacetoneacrylamide, and combinations thereof.

Suitable isocyanato functional ethylenically unsaturated compounds (iii8) may be selected from 2-isocyanate ethyl (meth)acrylate, allyl isocyanate, vinyl isocyanate, 3-isopropenyl-α,α-dimethylbenzyl isocyanate, and combinations thereof.

Suitable alkoxysilyl functional ethylenically unsaturated compounds (iii9) may be selected from allyl trimethoxysilane, allyl triethoxysilane, vinyl trimethoxy silane, vinyl triethoxy silane3-butenyltriethoxysilane, 3-(trimethoxysilyl)propyl (meth)acrylate, 5-hexenyltriethoxysilane, styrylethyltrimethoxysilane, trimethoxy(7-octen-1-yl)silane, 11-allyloxyundecyltrimethoxysilane, allylphenylpropyltriethoxysilane, [(5-bicyclo[2.2.1]hept-2-enyl)ethyl]trimethoxysilane, (5-bicyclo[2.2.1]hept-2-enyl)triethoxysilane, n-allyl-aza-2,2-dimethoxysilacyclopentane norbornenyltriethoxysilane, [2-(3-cyclohexenyl)ethyl]triethoxysilane, and combinations thereof.

Suitable alkoxy functional ethylenically unsaturated compounds (iii10) may be selected from N-methoxymethyl-(meth)acrylamide, N-n-butoxy-methyl-(meth)acrylamide, N-iso-butoxy-methyl-(meth)acrylamide, 2-methoxy ethyl (meth)acrylate, 2-ethoxyethyl (meth)acrylate, 2-butoxyethyl (meth)acrylate, methoxyethoxyethyl acrylate, methyl-3-methoxy(meth)acrylate, and combinations thereof. Preferred alkoxy functional ethylenically unsaturated compounds are 2-methoxy ethyl (meth)acrylate, 2-ethoxyethyl (meth)acrylate, methyl-3-methoxy(meth)acrylate, and combinations thereof.

Suitable dioxolanone functional ethylenically unsaturated compounds (iii11) may be selected from glycerol carbonate (meth)acrylate, 4-vinyl-1,3-dioxolan-2-one, and combinations thereof.

Suitable halide functional ethylenically unsaturated compounds (iii12) may be selected from vinyl chloride, allyl chloride, 2-chloro-1,3-butadiene, 2-chloroethyl acrylate, 3-chloro-2-hydroxypropyl methacrylate, methyl 2-(chloromethyl) (meth)acrylate, 2,3-dichloropropyl (meth)acrylate, 2,3-dibromopropyl (meth)acrylate, and combinations thereof.

Suitable thiol functional ethylenically unsaturated compounds (iii13) may be selected from allyl mercaptan, N-acryloyl-cysteamine, and combinations thereof.

Suitable hydroxylamine functional ethylenically unsaturated compounds (iii14) may be selected from acrylohydroxamic acid.

Suitable oxazolino functional ethylenically unsaturated compounds (iii15) may be selected from oxazoline substituted acrylic ester. Suitable oxazoline substituted acrylic esters and the synthesis thereof are described in U.S. Pat. No. 6,063,885.

Suitable aziridino functional ethylenically unsaturated compounds (iii16) may be selected from 2-(aziridine-1-yl)ethyl acrylate.

Suitable imino functional ethylenically unsaturated compounds (iii17) may be selected from 2-[(2-methylprop-2-enoyl)oxy]ethyl (3E)-3-(alkylimino)butanoate. Imino functional ethylenically unsaturated compounds (iii17) may be prepared by reaction of a primary or secondary amine with acetoacetoxyethyl (meth)acrylate as described in Esser, R. J., Devona, J. E., Setzke, D. E. and Wagemans L. Prog. Org. Coat., 1999, 36 (1-2) 45-52 &Yu, Z., Alesso, S., Pears, D., Worthington, P. A., Luke, R. W. A., Bradley, M., Tetrahedron Lett., 2000, 41 (46) 8963-8967.

Suitable carbodiimino functional ethylenically unsaturated compounds (iii18) may be selected from N-α,α′-dimethyl isopropenyl benzyl-N′-cyclohexyl carbodiimide, N-α,α′-dimethyl isopropenyl benzyl-N′-butyl carbodiimide, and combinations thereof. The synthesis of said carbodiimino functional ethylenically unsaturated compound is described in Pham, H. H. and Winnik, M. A., J Polym Sci A Polym Chem, 2000, 38, 855-869.

Suitable glycol functional ethylenically unsaturated compounds (iii19) may be selected from ethylene glycol methyl ether (meth)acrylate, ethylene glycol phenyl ether (meth)acrylate, di(ethylene glycol) methyl ether (meth)acrylate, tri(ethylene glycol) methyl ether (meth)acrylate, poly(ethylene glycol) methyl ether (meth)acrylate, poly(ethylene glycol) phenyl ether acrylate, poly(ethylene glycol) (meth)acrylate, poly(propylene glycol) (meth)acrylate poly(ethylene glycol)-block-poly(propylene glycol)-block-poly(ethylene glycol) (meth)acrylate, polyglycol partial ester monomer, and combinations thereof.

Suitable hydrazido functional ethylenically unsaturated compounds (iii20) may be selected from 2-propenoic acid hydrazide, methacryloyl hydrazide, and combinations thereof.

Suitable aldehyde functional ethylenically unsaturated compounds (iii21) may be selected from (meth)acrolein, 2-ethylacrolein,3-methyl-2-butenal, tiglic aldehyde, crotonaldehyde, 3-methylcrotonaldehyde, 2-pentenal, 2-methyl-2-pentenal, 4-pentenal,2,2-dimethyl-4-pentenal, 2,4-heptadienal, and combinations thereof.

Suitable ketone functional ethylenically unsaturated compounds (iii22) may be selected from 1-penten-3-one, 3-buten-2-one, 4-methoxy-3-buten-2-one, 3-penten-2-one, 2-cyclopenten-1-one, 2-cyclohexen-1-one, and combinations thereof.

The monomers (iii) provide functional groups (I-a) that are reactive with the functional group (III-b) of the silane compound (III) or with the functional groups (V-b) of the silane compound (V) according to the present invention. In addition, due to their polarity they may influence the properties of the polymer dispersion. The type and the amount of these monomers are determined thereby. Typically, such an amount is from 0.05 to 10 wt.-%, particularly from 0.1 to 10 wt.-% or 0.5 to 7 wt.-%, preferably from 0.1 to 9 wt.-%, more preferred from 0.1 to 8 wt.-%, even more preferred from 1 to 7 wt.-%, most preferred 2 to 7 wt.-%, based on the total weight of the ethylenically unsaturated monomers for the latex polymer (I). Thus, the ethylenically unsaturated compounds (iii) may be present in amounts of at least 0.01 wt.-%, at least 0.05 wt.-%, at least 0.1 wt.-%, at least 0.3 wt.-%, at least 0.5 wt.-%, at least 0.7 wt.-%, at least 0.9 wt.-%, at least 1 wt.-%, at least 1.2 wt.-%, at least 1.4 wt.-%, at least 1.6 wt.-%, at least 1.8 wt.-%, at least 2 wt.-%, at least 2.5 wt.-%, or at least 3 wt.-%. Likewise, the ethylenically unsaturated compounds (iii) may be present in amounts of no more than 10 wt.-%, no more than 9.5 wt.-%, no more than 9 wt.-%, no more than 8.5 wt.-%, no more than 8 wt.-%, no more than 7.5 wt.-%, no more than 7 wt.-%, no more than 6.5 wt.-%, no more than 6 wt.-%, no more than 5.5 wt.-%, or no more than 5 wt.-%, based on the total weight of ethylenically unsaturated monomers for latex polymer (I). A person skilled in the art will appreciate that any range defined by an explicitly disclosed lower limit and an explicitly disclosed upper limit is disclosed herewith.

Representatives of vinyl-aromatic monomers (iv) include, for example, styrene, α-methylstyrene, vinyltoluene, o-methylstyrene, p-methylstyrene, p-tert-butylstyrene, 2,4-dimethylstyrene, 2-methylstyrene, 3-methylstyrene, 4-methylstyrene, 2-ethylstyrene, 3-ethylstyrene, 4-ethylstyrene, 2,4-diisopropylstyrene, 2,4-dimethylstyrene, 4-tert-butylstyrene, 5-tert-butyl-2-methylstyrene, vinylnaphthalene, vinyltoluene, vinylxylene, 2-vinylpyridine, 4-vinylpyridine, 1,1-diphenylethylenes, 1,2-diphenylethene. Mixtures of one or more of the vinyl-aromatic compounds (vi) may also be used. Preferably, vinyl-aromatic monomers (iv) are selected from styrene, a-methylstyrene, and combinations thereof. The vinyl-aromatic compounds (vi) can be used in a range of from 0 to 80 wt.-%, or 0 to 70 wt.-%, or 0 to 50 wt.-%, preferably from 0 to 40 wt.-% more preferred from 0 to 25 wt.-%, even more preferred from 0 to 15 wt.-%, and most preferred from 0 to 10 wt.-%, based on the total weight of ethylenically unsaturated monomers for the latex polymer (I). Thus, the vinyl-aromatic compound (iv) can be present in an amount of no more than 80 wt.-%, no more than 75 wt.-%, no more than 60 wt.-%, no more than 50 wt.-%, no more than 40 wt.-%, no more than 35 wt.-%, no more than 30 wt.-%, no more than 25 wt.-%, no more than 20 wt.-%, no more than 18 wt.-%, no more than 16 wt.-%, no more than 14 wt.-%, no more than 12 wt.-%, no more than 10 wt.-%, no more than 8 wt.-%, no more than 6 wt.-%, no more than 4 wt.-%, no more than 2 wt.-%, or no more than 1 wt.-%, based on the total weight of ethylenically unsaturated monomers for latex polymer (I). Vinyl-aromatic compounds (iv) may also be completely absent.

Suitable alkyl ester of ethylenically unsaturated acids (v) may be selected from n-alkyl esters, iso-alkyl esters or tert-alkyl esters of (meth)acrylic acid in which the alkyl group has from 1 to 20 carbon atoms and the reaction product of methacrylic acid with glycidyl ester of a neoacid such as versatic acid, neodecanoic acid or pivalic acid.

In general, the preferred alkyl esters of (meth)acrylic acids may be selected from C₁-C₁₀ alkyl (meth)acrylate, preferably C₁-C₈-alkyl (meth)acrylates. Examples of such (meth)acrylate monomers include n-butyl acrylate, secondary butyl acrylate, ethyl acrylate, hexyl acrylate, tert-butyl acrylate, 2-ethyl-hexyl acrylate, isooctyl acrylate, 4-methyl-2-pentyl acrylate, 2-methylbutyl acrylate, methyl methacrylate, tert-butyl methacrylate, n-butyl methacrylate, isobutyl methacrylate, ethyl methacrylate, isopropyl methacrylate, hexyl methacrylate, cyclohexyl methacrylate and cetyl methacrylate. Methyl (meth)acrylate, ethyl (meth)acrylate, propyl (meth)acrylate, butyl (meth)acrylate, 2-ethylhexyl (meth)acrylate and combinations thereof are preferred.

Typically, the alkyl esters of ethylenically unsaturated acids (v) can be present in an amount of no more than 65 wt.-%, no more than 60 wt.-%, no more than 55 wt.-%, no more than 50 wt.-%, no more than 45 wt.-%, no more than 40 wt.-%, no more than 35 wt.-%, no more than 30 wt.-%, no more than 25 wt.-%, no more than 20 wt.-%, no more than 18 wt.-%, no more than 16 wt.-%, no more than 14 wt.-%, no more than 12 wt.-%, no more than 10 wt.-%, no more than 8 wt.-%, no more than 6 wt.-%, no more than 4 wt.-%, no more than 2 wt.-%, or no more than 1 wt.-%, based on the total weight of ethylenically unsaturated monomers for latex polymer (I).

Further, the mixture of ethylenically unsaturated monomers for latex polymer (I) according to the present invention may include additional ethylenically unsaturated monomers that are different from the above-defined monomers. These monomers may be selected from vinyl carboxylates (vi) and/or monomers having two identical ethylenically unsaturated groups (vii).

Vinyl carboxylate monomers (vi) which can be used according to the present invention include vinyl acetate, vinyl propionate, vinyl butyrate, vinyl benzoate, vinyl-2-ethylhexanoate, vinyl stearate, and the vinyl esters of versatic acid. The most preferred vinyl ester monomer for use in the present invention is vinyl acetate. Typically, the vinyl ester monomers can be present in an amount of no more than 18 wt.-%, no more than 16 wt.-%, no more than 14 wt.-%, no more than 12 wt.-%, no more than 10 wt.-%, no more than 8 wt.-%, no more than 6 wt.-%, no more than 4 wt.-%, no more than 2 wt.-%, or no more than 1 wt.-%, based on the total weight of ethylenically unsaturated monomers for latex polymer (I).

Furthermore, monomers having at least two identical ethylenically unsaturated groups (vii) can be present in the monomer mixture for the preparation of the polymer latex of the present invention in an amount of 0 to 6.0 wt.-%, preferably 0.1 to 3.5 wt.-%, based on the total weight of ethylenically unsaturated monomers for latex polymer (I). Typically, these monomers can be present in an amount of no more than 6 wt.-%, no more than 4 wt.-%, no more than 2 wt.-%, no more than 1 wt.-%, based on the total weight of ethylenically unsaturated monomers for the latex polymer (I). Suitable bifunctional monomers (vii) which are capable of providing internal crosslinking and branching in the polymer (herein known as multifunctional monomers) may be selected from divinyl benzene and diacrylates and di(meth)acrylates. Examples are ethylene glycol di(meth)acrylate, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, and dipropylene glycol di(meth)acrylate. The monomers having at least two ethylenically unsaturated groups (vii) are preferably selected from divinyl benzene, 1,2 ethyleneglycol di(meth)acrylate, 1,4-butanediol di(meth)acrylate and 1,6-hexanediol di(meth)acrylate, and combinations thereof.

According to the present invention, the amounts of the above-defined monomers for the preparation of latex polymer (I) may add up to 100 wt.-%.

### Method for the Preparation of the Polymer Latex of the Present Invention:

The latex polymer (I) according to the present invention can be made by any emulsion polymerization process known to a person skilled in the art, provided that the monomer mixture as herein defined is employed. Particularly suitable is the process as described in EP-A 792 891.

In the emulsion polymerization for preparing the latex polymer (I) of the present invention a seed latex may be employed. Any seed particles as known to the person skilled in the art can be used.

The seed latex particles are preferably present in an amount of 0.01 to 10, preferably 1 to 5 parts by weight, based on 100 parts by weight of total ethylenically unsaturated monomers employed in the polymer. The lower limit of the amount of seed latex particles therefore can be 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 parts by weight. The upper limit of the amount can be 10, 9, 8, 7, 6, 5.5, 5, 4.5, 4, 3.8, 3.6, 3.4, 3.3, 3.2, 3.1 or 3 parts by weight. A person skilled in the art will understand that any range formed by any of the explicitly disclosed lower limits and upper limits is explicitly encompassed in the present specification.

The process for the preparation of the above-described polymer latex can be performed at temperatures of from 0 to 130° C., preferably of from 0 to 100° C., particularly preferably of from 5 to 70° C., very particularly preferably of from 5 to 60° C., in the presence of no or one or more emulsifiers, no or one or more colloids and one or more initiators. The temperature includes all values and sub-values therebetween, especially including 5, 10, 15, 20, 25, 30, 35, 40, 45, 50, 55, 60, 65, 70, 75, 80, 85, 90, 95, 100, 105, 110, 115, 120 and 125° C.

Initiators which can be used when carrying out the present invention include water-soluble and/or oil-soluble initiators which are effective for the purposes of the polymerization. Representative initiators are well known in the technical area and include, for example: azo compounds (such as, for example, AIBN, AMBN and cyanovaleric acid) and inorganic peroxy compounds, such as hydrogen peroxide, sodium, potassium and ammonium peroxydisulfate, peroxycarbonates and peroxyborates, as well as organic peroxy compounds, such as alkyl hydroperoxides, dialkyl peroxides, acyl hydroperoxides, and diacyl peroxides, as well as esters, such as tertiary butyl perbenzoate and combinations of inorganic and organic initiators.

The initiator is used in a sufficient amount to initiate the polymerization reaction at a desired rate. In general, an amount of initiator of from 0.01 to 5 wt.-%, preferably of from 0.1 to 4 wt.-%, based on the total weight of monomers in the monomer composition, is sufficient. The amount of initiator is most preferably of from 0.01 to 2 wt.-%, based on the total weight of monomers in the monomer composition. The amount of initiator includes all values and sub-values therebetween, especially including 0.01, 0.1, 0.5, 1, 1.5, 2, 2.5, 3, 4 and 4.5 wt.-%, based on the total weight of monomers in the monomer composition.

The above-mentioned inorganic and organic peroxy compounds may also be used alone or in combination with one or more suitable reducing agents, as is well known in the art. Examples of such reducing agents may include sulfur dioxide, alkali metal disulfites, alkali metal and ammonium hydrogen sulfites, thiosulfates, dithionites and formaldehyde sulfoxylates, as well as hydroxylamine hydrochloride, hydrazine sulfate, iron (II) sulfate, cuprous naphthanate, glucose, sulfonic acid compounds such as sodium methane sulfonate, amine compounds such as dimethylaniline and ascorbic acid. The quantity of the reducing agent is preferably 0.03 to 10 parts by weight per part by weight of the polymerization initiator.

Surfactants or emulsifiers which are suitable for stabilizing the latex particles include those conventional surface-active agents for polymerization processes. The surfactant or surfactants can be added to the aqueous phase and/or the monomer phase. An effective amount of surfactant in a seed process is the amount which was chosen for supporting the stabilization of the particle as a colloid, the minimization of contact between the particles and the prevention of coagulation. In a non-seeded process, an effective amount of surfactant is the amount which was chosen for influencing the particle size.

Representative surfactants include saturated and ethylenically unsaturated sulfonic acids or salts thereof, including, for example, unsaturated hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of acrylic acid and methacrylic acid, such as, for example, sulfoethyl methacrylate and sulfopropyl methacrylate and salts thereof, and 2-acrylamido-2-methylpropanesulfonic acid and salts thereof; alkylated diphenyl oxide disulfonates, sodium dodecylbenzenesulfonates and dihexyl esters of sodium sulfosuccinate, Sodium alkyl esters of sulfonic acid, ethoxylated alkylphenols and ethoxylated alcohols; fatty alcohol (poly)ethersulfates.

The type and the amount of the surfactant is governed typically by the number of particles, their size and their composition. Typically, the surfactant is used in amounts of from 0 to 20 wt.-%, preferably from 0 to 10 wt.-%, more preferably from 0 to 5 wt.-%, based on the total weight of the monomers in the monomer composition. The amount of surfactant includes all values and sub-values therebetween, especially including 0, 0.1, 0.5, 1, 2, 3, 4, 5, 6, 7, 8, 9, 10, 11, 12, 13, 14, 15, 16, 17, 18 and 19 wt.-%, based on the total weight of the monomer in the monomer composition. The polymerization may be conducted without using surfactants.

Various protective colloids can also be used instead of or in addition to the surfactants described above. Suitable colloids include polyhydroxy compounds, such as partially acetylated polyvinyl alcohol, casein, hydroxyethyl starch, carboxymethylcellulose, hydroxyethylcellulose, hydroxypropylcellulose, polysaccharides, and degraded polysaccharides, polyethylene glycol and gum arabic. The preferred protective colloids are carboxymethylcellulose, hydroxyethylcellulose and hydroxypropylcellulose. In general, these protective colloids are used in contents of from 0 to 10 parts by weight, preferably from 0 to 5 parts by weight, more preferably from 0 to 2 parts by weight, based on the total weight of the monomers. The amount of protective colloids includes all values and sub-values therebetween, especially including 1, 2, 3, 4, 5, 6, 7, 8 and 9 wt.-%, based on the total weight of the monomers.

The person skilled in the art will appreciate the type and amounts of monomers bearing polar functional groups, surfactants and protective colloids that are to be selected to make the polymer latex according to the present invention suitable for dip-molding applications. Thus, it is preferred that the polymer latex composition of the present invention has a certain maximum electrolyte stability determined as critical coagulation concentration of less than 30 mmol/l CaCl₂, preferably less than 25 mmol/l, more preferred less than 20 mmol/l, most preferred less than 10 mmol/l (determined for a total solids content of the composition of 0.1% at pH 10 and 23° C.).

If the electrolyte stability is too high, then it will be difficult to coagulate the polymer latex in a dip-molding process, with the result that either no continuous film of the polymer latex on the immersed mold is formed or the thickness of the resulting product is non-uniform.

It is within the routine of the person skilled in the art to appropriately adjust the electrolyte stability of a polymer latex. The electrolyte stability will depend on certain different factors, for example, amount and selection of monomers to be used for making the polymer latex, especially monomers containing polar-functional groups, as well as the selection and amount of the stabilizing system, for example, the emulsion polymerization process for making the polymer latex. The stabilizing system may contain surface-active agents and/or protective colloids.

A person skilled in the art is able, depending on the selected monomers and their relative amounts for making the polymer latex of the present invention, to adjust the stabilizing system in order to achieve an electrolyte stability according to the present invention.

It is frequently advisable to perform the emulsion polymerization additionally in the presence of buffer substances and chelating agents. Suitable substances are, for example, alkali metal phosphates and pyrophosphates (buffer substances) and the alkali metal salts of ethylenediaminetetraacetic acid (EDTA) or hydroxyl-2-ethylenediaminetriacetic acid (HEEDTA) as chelating agents. The quantity of buffer substances and chelating agents is usually 0.001-1.0 wt.-%, based on the total quantity of monomers.

Furthermore, it may be advantageous to use chain transfer agents (regulators) in emulsion polymerization. Typical agents are, for example, organic sulfur compounds, such as thioesters, 2-mercaptoethanol, 3-mercaptopropionic acid and C₁-C₁₂ alkyl mercaptans, n-dodecylmercaptan and t-dodecylmercaptan being preferred. The quantity of chain transfer agents, if present, is usually 0.05-3.0 wt.-%, preferably 0.2-2.0 wt.-%, based on the total weight of the used monomers.

Furthermore, it can be beneficial to introduce partial neutralization to the polymerization process. A person skilled in the art will appreciate that by appropriate selection of this parameter the necessary control can be achieved.

Various other additives and ingredients can be added in order to prepare the latex composition of the present invention. Such additives include, for example: antifoams, wetting agents, thickeners, plasticizers, fillers, pigments, dispersants, optical brighteners, crosslinking agents, accelerators, antioxidants, biocides and metal chelating agents. Known antifoams include silicone oils and acetylene glycols. Customary known wetting agents include alkylphenol ethoxylates, alkali metal dialkylsulfosuccinates, acetylene glycols and alkali metal alkylsulfate. Typical thickeners include polyacrylates, polyacrylamides, xanthan gums, modified celluloses or particulate thickeners, such as silicas and clays. Typical plasticizers include mineral oil, liquid polybutenes, liquid polyacrylates and lanolin. Zinc oxide is a suitable crosslinking agent. Titanium dioxide (TiO₂), calcium carbonate and clay are the fillers typically used. Known accelerators and secondary accelerators include dithiocarbamates like zinc diethyl dithiocarbamate, zinc dibutyl dithiocarbamate, zinc dibenyl dithiocarbamate, zinc pentamethylene dithiocarbamate (ZPD), xanthates, thiurams like tetramethylthiuram monosulfide (TMTM), tetramethylthiuram disulfide (TMTD), tetraethylthiuram disulfide (TETD), dipentamethylenethiuram hexasulfide (DPTT), and amines, such as diphenylguanidine (DPG), di-o-tolylguanidine (DOTG), and o-tolylbiguanidine (OTBG).

### Silane Compound (II) Comprising at Least Two Terminal Silane Functional Groups (II-a) and a Thermally Reversible Bond (II-b):

According to the present invention, any silane compound (II) can be used that comprises at least two terminal silane functional groups (II-a) and a thermally reversible bond (II-b). The silane compound (II) may ensure that the elastomeric film of the final dip-molded article exhibits the desired mechanical properties even if no sulfur vulcanization is used.

The thermally reversible bond (II-b) may be selected from the group consisting of disulfide, tetrasulfide, carbonate, urea, thiourea, ester, beta-hydroxy ester, thioester, beta-hydroxy amine, beta-hydroxy thioether, amide, urethane, enamine, imine, hemiacetal, acetal, hemiketal, ketal, boronate ester, siloxane, oxime, acylhydrazone, aldol, thiuram disulfide and trithiocarbonate.

According to the present invention, the silane compound (II) may have the structural formula:

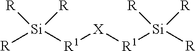

wherein X is the thermally reversible bond (II-b), preferably selected from the group comprising disulfide, tetrasulfide, carbonate, urea, thiourea, ester, beta-hydroxy ester, thioester, beta-hydroxy amine, beta-hydroxy thioether, amide, urethane, enamine, imine, hemiacetal, acetal, hemiketal, ketal, boronate ester, siloxane, oxime, acylhydrazone, aldol, thiuram disulfide and trithiocarbonate; R is independently selected from hydrogen, halogen, hydroxyl, alkoxy, hydrocarbyl, silane or mixtures thereof; and R¹ independently is a linear or a branched C₁-C₂₀ alkanediyl, cyclic C₃-C₂₀ alkyl or alkenyl, or arylenediyl, preferably a linear C₁-C₂₀ alkanediyl.

Suitable silane compounds (II) may be selected from bis[3-(trialkoxysilylpropyl)]disulfide, bis[3-(trialkoxysilyl)propyl] tetrasulfide, bis[3-(trialkoxysilyl)propyl]carbonate, N,N′-bis[3-(trialkoxysilyl)propyl] urea, N,N′-bis[3-(trialkoxysilyl)propyl]thiourea, 2-hydroxy-3-[3-(trialkoxysilyl)propoxy]propyl 3-(trihydroxysilyl)propanoate, 2-hydroxy-7-(trialkoxysilyl)heptyl 3-(trihydroxysilyl)propanoate, 9,9-dialkoxy-1,1,1-trihydroxy-10-oxa-5-thia-1,9-disiladodecan-4-one, N-[3-(trialkoxysilyl)propyl]-3-(trihydroxysilyl)propenamide, (trialkoxysilyl)methyl N-[3-(trialkoxysilyl)propyl]carbamate, (7E)-4,4,12,12-tetraalkoxy-3,13-dioxa-8-aza-4,12-disilapentadec-7-ene, 4,4,11,11-tetraalkoxy-3,6,12-trioxa-4,11-disilatetradecan-7-ol, 4,4,10,10-tetraalkoxy-7-[3-(trialkoxysilyl)propyl]-3,6,8,11-tetraoxa-4,10-disilatridecane, oligomeric siloxanes and combinations thereof. Preferably, the alkoxy group is selected from a methoxy group, and an ethoxy group, more preferably from an ethoxy group. As used herein, the term “oligomeric siloxanes” refers to siloxane having a weight average molecular weight (Mw) in the range of from 200 to 2,000 Da, determined according to GPC using polystyrene as standard as described in U.S. Pat. No. 8,728,345 B2. Suitable examples of oligomeric siloxane include CoatOSil MP-200, CoatOSil T-Cure and Silquest VX-225, all commercially available from Momentive Performance Materials (USA).

Preferably, the silane compound (II) may be selected from bis[3-(triethoxysilylpropyl)] disulfide, bis[3-(triethoxysilyl)propyl] tetrasulfide, bis[3-(triethoxysilyl)propyl] carbonate, N,N′-bis[3-(triethoxysilyl)propyl] urea, N,N′-bis[3-(triethoxysilyl)propyl] thiourea, 2-hydroxy-3-[3-(triethoxysilyl)propoxy]propyl 3-(trihydroxysilyl)propanoate, 2-hydroxy-7-(triethoxysilyl)heptyl 3-(trihydroxysilyl)propanoate, 9,9-diethoxy-1,1,1-trihydroxy-10-oxa-5-thia-1,9-disiladodecan-4-one, N-[3-(triethoxysilyl)propyl]-3-(trihydroxysilyl)propenamide, (triethoxysilyl)methyl N-[3-(triethoxysilyl)propyl]carbamate, (7E)-4,4,12,12-tetraethoxy-3,13-dioxa-8-aza-4,12-disilapentadec-7-ene, 4,4,11,11-tetraethoxy-3,6,12-trioxa-4,11-disilatetradecan-7-ol, 4,4,10,10-tetraethoxy-7-[3-(triethoxysilyl)propyl]-3,6,8,11-tetraoxa-4,10-disilatridecane, oligomeric siloxanes and combinations thereof.

Alternatively, the silane compound (II) of the present invention may be formed in situ in the polymer latex composition from a first compound (IV) comprising one terminal silane functional group (IV-a) and at least one additional functional group (IV-b) capable to form a thermally reversible bond (IV-c) with the additional functional group (IV-b) of a second silane compound (IV). According to the present invention, the first silane compound can be the same as the second silane compound or the first silane compound can be different to the second silane compound. A person skilled in the art, will understand that the additional functional group (IV-b) of the first silane compound needs to be capable to form a thermally reversible bond (IV-c) with the additional functional group of the second silane compound.

The at least one additional functional group (IV-b) of the first silane compound (IV) and/or the at least one additional functional group (IV-b) of the second silane compound (IV) may be blocked. As used herein, the term “blocked” refers to adducts derived from the reaction of the functional group of a compound with a blocking agent, whereby the adduct is thermally instable and dissociates (unblocks) at elevated temperatures, such as temperatures of above 40° C. Examples of suitable blocking agents include those materials which would unblock during heat treatment of the polymer latex composition, e.g., at temperatures in the range of from 40 to 120° C., such as from 60 to 120° C. A person skilled in the art will understand that a suitable blocking is dependent from the respective functional group. For example, amino functional groups and hydroxy functional groups may be blocked with tert-butylcarbonyl. Thiol functional groups may be blocked with (C₅ to C₉) alkyl carboxylic acids. Isocyanato functional groups may be blocked with aliphatic alcohols having 1 to 6 carbon atoms, such as methanol and n-butanol, cycloaliphatic alcohols, such as cyclohexanol, and phenolic compounds, such as phenol. A suitable blocked silane compound includes S-(octanoyl) mercaptopropyl trialkoxysilane, such as S-(octanoyl) mercaptopropyl triethoxysilane.

According to the present invention, the silane compound (IV) may have the structural formula:

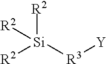

wherein R² is independently selected from hydrogen, halogen, hydroxyl, alkoxy, hydrocarbyl or mixtures thereof; R³ is linear or branched C₁-C₂₀ alkanediyl, cyclic C₃-C₂₀ alkyl or alkenyl, or arylenediyl, preferably linear C₁-C₂₀ alkanediyl; and Y is the functional group (IV-b).

The functional group (IV-b) preferably may be selected from the group consisting of epoxy, thiol, hydroxy, hydroxylamine, primary or secondary amino, isocyanato, oxazolino, aziridino, imino, carbodiimido, glycol, ester, acetoxy, carboxyl acid, dioxolanone, hydrazido, aldehyde, ketone and combinations thereof.

Suitable silane compounds (IV) may be selected from (3-glycidyloxypropyl) trialkoxysilane, beta-(3,4-epoxycyclohexylethyl trialkoxysilane), dialkoxy (3-glycidyloxypropyl)alkylsilane, 3-glycidoxypropyldialkylalkoxysilane, 5,6-epoxyhexyltrialkoxysilane, amino propyl trialkoxysilane, hydroxymethyltrialkoxysilane, 3-mercaptopropyltrialkoxysilane, 3-chloropropyltrialkoxysilane, vinyltrialkoxysilane, 3-(trialkoxysilyl)furan, norbonenyltrialkoxysilane, carboxyethyl silanetriol, 3-isocyanatopropyltrialkoxysilane, tris[3-(trialkoxysilyl)propyl] isocyanurate, trialkoxysilyl butyraldehyde, ureidopropyltrialkoxysilane, cyanomethyl [3-(trialkoxysilyl)propyl] trithiocarbonate, S-(octanoyl) mercaptopropyl trialkoxysilane and combinations thereof. Preferably, the alkoxy group is selected from a methoxy group, and an ethoxy group, more preferably from an ethoxy group.

Preferably, the silane compound (IV) may be selected from (3-glycidyloxypropyl) trimethoxysilane, (3-glycidyloxypropyl) triethoxysilane, beta-(3,4-epoxycyclohexylethyl trimethoxysilane), diethoxy (3-glycidyloxypropyl)methylsilane, 3-glycidoxypropyldimethylethoxysilane, 5,6-epoxyhexyltriethoxysilane, amino propyl triethoxysilane, hydroxymethyltriethoxysilane, 3-mercaptopropyltriethoxysilane, 3-chloropropyltrimethoxysilane, vinyltriethoxysilane, 3-(triethoxysilyl)furan, norbonenyltriethoxysilane, carboxyethyl silanetriol, 3-isocyanatopropyltriethoxysilane, tris[3-(trimethoxysilyl)propyl] isocyanurate, triethoxysilyl butyraldehyde, ureidopropyltrimethoxysilane, cyanomethyl [3-(trimethoxysilyl)propyl]trithiocarbonate, S-(octanoyl) mercaptopropyl triethoxysilane and combinations thereof.

The polymer latex composition of the present invention may comprise 80 to 99.9 wt.-%, preferably 85 to 99.9 wt.-%, more preferred 90 to 99.9 wt.-%. even more preferred 92 to 99.8 wt.-% and most preferred 95 to 99.8 wt.-% of the latex polymer (I), based on the total weight of the particles of a latex polymer (I) and the silane compound(s) of the present invention described herein. Thus, the lower limit for the amount of particles of latex polymer (I) may be 80 wt.-%, or 82 wt.-%, or 85 wt.-%, or 86 wt.-%, or 88 wt.-%, or 90 wt.-%, or 92 wt.-%, or 94 wt.-%, or 95 wt.-% based on the total weight of the particles of a latex polymer (I) and the silane compound(s) of the present invention described herein. The upper limit for the amount of particles of latex polymer (I) may be 99.9 wt.-%, or 99.8 wt.-%, or 99.5 wt.-%, or 99.2 wt.-%, or 99 wt.-%, or 98 wt.-%, or 97 wt.-%, or 96 wt.-%, based on the total weight of the particles of a latex polymer (I) and the silane compound(s) of the present invention described herein. The polymer latex composition of the present invention may comprise 0.1 to 20 wt.-%, preferably 0.1 to 15 wt.-%, more preferred 0.1 to 10 wt.-%, even more preferred 0.2 to 8 wt.-%, most preferred 0.2 to 5 wt.-% of the silane compound (II), based on the total weight of the particles of a latex polymer (I) and the silane compound(s) of the present invention described herein. The lower limit for the amount of the silane compound (II) may be 0.1 wt.-%, or 0.2 wt.-%, or 0.3 wt.-%, or 0.4 wt.-%, or 0.5 wt.-% or 0.6 wt.-%, or 0.8 wt.-%, or 1 wt.-%, or 1.5 wt.-%, or 2 wt.-%, or 2.5 wt.-%, or 3 wt.-%, based on the total weight of the particles of a latex polymer (I), and the silane compound(s) of the present invention described herein. The upper limit for the amount of the silane compound (II) may be 20 wt.-%, or 18 wt.-%, or 15 wt.-%, or 14 wt.-%, or 12 wt.-%, or 10 wt.-%, or 9 wt.-%, or 8 wt.-% or 5 wt.-%, based on the total weight of the particles of a latex polymer (I), and the silane compound(s) of the present invention described herein. A person skilled in the art will understand that any range formed by any of the explicitly disclosed lower limits and upper limits is explicitly disclosed in the present specification.

The latex composition of the present invention comprising silane compound (II) may further comprise a silane compound (V), wherein the silane compound (V) comprises (V-a) one terminal silane functional group and (V-b) at least one additional functional group reactive with the functional group (I-a) of the latex polymer (I). The combination of the silane compound (II) and silane compound (V) surprisingly improves the elongation at break (EB) of the final dip-molded article.

Depending on the type of the functional group (I-a) on the latex polymer (I), the functional group (V-b) of the silane compound (V) may be selected from carbon-carbon double bond, halide functional group, epoxy, thiol, hydroxy, hydroxylamine, primary or secondary amino, isocyanato, oxazolino, aziridino, imino, carbodiimido, glycol, ester, acetoxy, carboxyl acid, dioxolanone, hydrazido, aldehyde, ketone and combinations thereof.

According to the present invention, the silane compound (V) may have the structural formula:

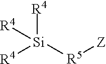

wherein R⁴ is independently selected from hydrogen, halogen, hydroxyl, alkoxy, hydrocarbyl or mixtures thereof; R⁵ is linear or branched C₁-C₂₀ alkanediyl, cyclic C₃-C₂₀ alkyl or alkenyl, or arylenediyl, preferably linear C₁-C₂₀ alkanediyl; and Z is the functional group (V-b) reactive with the functional groups (I-a) of the particles of the latex polymer (I). Preferably the functional group (V-b) may be selected from carbon-carbon double bond, halide functional group, epoxy, thiol, hydroxy, hydroxylamine, primary or secondary amino, isocyanato, oxazolino, aziridino, imino, carbodiimido, glycol, ester, acetoxy, carboxyl acid, dioxolanone, hydrazido, aldehyde, ketone and combinations thereof. The functional group (V-b) of the silane compound (V) may be blocked as described above.

Suitable silane compounds (V) may be selected from (3-glycidyloxypropyl) trialkoxysilane, beta-(3,4-epoxycyclohexylethyl trialkoxysilane), dialkoxy (3-glycidyloxypropyl)alkylsilane, 3-glycidoxypropyldialkylalkoxysilane, 5,6-epoxyhexyltrialkoxysilane, amino propyl trialkoxysilane, hydroxymethyltrialkoxysilane, 3-mercaptopropyltrialkoxysilane, 3-chloropropyltrialkoxysilane, vinyltrialkoxysilane, 3-(trialkoxysilyl)furan, norbonenyltrialkoxysilane, carboxyethyl silanetriol, 3-isocyanatopropyltrialkoxysilane, tris[3-(trialkoxysilyl)propyl] isocyanurate, trialkoxysilyl butyraldehyde, ureidopropyltrialkoxysilane, cyanomethyl [3-(trialkoxysilyl)propyl] trithiocarbonate, S-(octanoyl) mercaptopropyl trialkoxysilane and combinations thereof. Preferably, the alkoxy group is selected from a methoxy group, and an ethoxy group, more preferably from an ethoxy group.

Preferably, the silane compound (V) may be selected from (3-glycidyloxypropyl) trimethoxysilane, (3-glycidyloxypropyl) triethoxysilane, beta-(3,4-epoxycyclohexylethyl trimethoxysilane), diethoxy (3-glycidyloxypropyl)methylsilane, 3-glycidoxypropyldimethylethoxysilane, 5,6-epoxyhexyltriethoxysilane, amino propyl triethoxysilane, hydroxymethyltriethoxysilane, 3-mercaptopropyltriethoxysilane, 3-chloropropyltrimethoxysilane, vinyltriethoxysilane, 3-(triethoxysilyl)furan, norbonenyltriethoxysilane, carboxyethyl silanetriol, 3-isocyanatopropyltriethoxysilane, tris[3-(trimethoxysilyl)propyl] isocyanurate, triethoxysilyl butyraldehyde, ureidopropyltrimethoxysilane, cyanomethyl [3-(trimethoxysilyl)propyl]trithiocarbonate, S-(octanoyl) mercaptopropyl triethoxysilane and combinations thereof.

The polymer latex composition of the present invention may comprise 80 to 99.8 wt.-%, preferably 85 to 99.8 wt.-%, more preferred 90 to 99.5 wt.-%, even more preferred 92 to 99.5 wt.-% and most preferred 95 to 99.2 wt.-% of the latex polymer (I), based on the total weight of the particles of a latex polymer (I) and the silane compound(s) of the present invention described herein. Thus, the lower limit for the amount of particles of latex polymer (I) may be 80 wt.-%, or 82 wt.-%, or 85 wt.-%, or 86 wt.-%, or 88 wt.-%, or 90 wt.-%, or 92 wt.-% based on the total weight of the particles of a latex polymer (I) and the silane compound(s) of the present invention described herein. The upper limit for the amount of particles of latex polymer (I) may be 99.8 wt.-%, or 99.5 wt.-%, or 99.2 wt.-%, or 99 wt.-%, or 98 wt.-%, or 97 wt.-%, or 96 wt.-%, or 95 wt.-%, or 94 wt.-%, or 93 wt.-%, based on the total weight of the particles of a latex polymer (I) and the silane compound(s) of the present invention described herein. The polymer latex composition of the present invention may comprise 0.1 to 20 wt.-%, preferably 0.1 to 15 wt.-%, more preferred 0.1 to 10 wt.-%, even more preferred 0.2 to 8 wt.-%, most preferred 0.2 to 5 wt.-% of the silane compound (II), based on the total weight of the particles of a latex polymer (I) and the silane compound(s) of the present invention described herein. The lower limit for the amount of the silane compound (II) may be 0.1 wt.-%, or 0.2 wt.-%, or 0.3 wt.-%, or 0.4 wt.-%, or 0.5 wt.-% or 0.6 wt.-%, or 0.8 wt.-%, or 1 wt.-%, or 1.5 wt.-%, or 2 wt.-%, or 2.5 wt.-%, or 3 wt.-%, based on the total weight of the particles of a latex polymer (I) and the silane compound(s) of the present invention described herein. The upper limit for the amount of silane compound (II) may be 20 wt.-%, or 18 wt.-%, or 15 wt.-%, or 14 wt.-%, or 12 wt.-%, or 10 wt.-%, or 9 wt.-%, or 8 wt.-% or 5 wt.-%, based on the total weight of the particles of a latex polymer (I) and the silane compound(s) of the present invention described herein. The polymer latex composition of the present invention may comprise 0.1 to 20 wt.-%, preferably 0.1 to 15 wt.-%, more preferred 0.1 to 10 wt.-%, even more preferred 0.2 to 8 wt.-%, most preferred 0.2 to 5 wt.-% of the silane compound (V), based on the total weight of the particles of a latex polymer (I) and the silane compound(s) of the present invention described herein. The lower limit for the amount of the silane compound (V) may be 0.1 wt.-%, or 0.2 wt.-%, or 0.3 wt.-%, or 0.4 wt.-%, or 0.5 wt.-% or 0.6 wt.-%, or 0.8 wt.-%, or 1 wt.-%, or 1.5 wt.-%, or 2 wt.-%, or 2.5 wt.-%, or 3 wt.-%, based on the total weight of the particles of a latex polymer (I) and the silane compound(s) of the present invention described herein. The upper limit for the amount of silane compound (V) may be 20 wt.-%, or 18 wt.-%, or 15 wt.-%, or 14 wt.-%, or 12 wt.-%, or 10 wt.-%, or 9 wt.-%, or 8 wt.-% or 5 wt.-%, based on the total weight of the particles of a latex polymer (I) and the silane compound(s) of the present invention described herein. A person skilled in the art will understand that any range formed by any of the explicitly disclosed lower limits and upper limits is explicitly disclosed in the present specification.

The mass ratio of the silane compound (II) to the silane compound (V) may be from 100:1 to 1:100, preferably from 80:1 to 1:80, more preferred 50:1 to 1:50, even more preferred from 20:1 to 1:20, most preferred 10:1 to 1:10.

Functional groups (I-a) on the latex polymer (I) and functional groups (V-b) of the silane compound (V) may be selected to provide the following combinations:
the functional groups (I-a) are selected from groups having a carbon-carbon double bond and the functional groups (V-b) are selected from groups having carbon-carbon double bonds and thiol;
the functional groups (I-a) are selected from carboxylic acid functional groups and the functional groups (V-b) are selected from epoxy, thiol, hydroxy, primary or secondary amino, isocyanato, oxazolino, aziridino, imino, carbodiimido, glycol groups, ester groups, and acetoxy;
the functional groups (I-a) are selected from hydroxyl and the functional groups (V-b) are selected from alkoxysilyl, carboxylic acid functional groups; isocyanato, primary or secondary amino, aldehyde, boronic acid and ester groups;
the functional groups (I-a) are selected from epoxy and the functional groups (V-b) are selected from carboxylic acid functional groups, hydroxyl and ester groups;
the functional groups (I-a) are selected from acetoacetyl and the functional groups (V-b) are selected from groups having carbon-carbon double bonds, isocyanato, aldehyde, hydrazine, hydrazide and primary or secondary amino;
the functional groups (I-a) are selected from primary or secondary amino and the functional groups (V-b) are selected from carboxylic acid functional groups, epoxy, ester groups and dioxolanone groups;
the functional groups (I-a) are selected from acetoxy and the functional groups (V-b) are selected from hydrazido and primary or secondary amino;
the functional groups (I-a) are selected from isocyanato and the functional groups (V-b) are selected from carboxylic acid functional groups. hydroxyl, primary or secondary amino and thiol;
the functional groups (I-a) are selected from alkoxysilyl and the functional groups (V-b) are selected from hydroxyl and alkoxysilyl;
the functional groups (I-a) are selected from alkoxy and the functional groups (V-b) are selected from ester groups;
the functional groups (I-a) are selected from ester groups and the functional groups (V-b) are selected from hydroxyl, carboxylic acid groups and ester groups;
the functional groups (I-a) are selected from dioxolanone groups and the functional groups (V-b) are selected from primary or secondary amino;
the functional groups (I-a) are selected from halide functional groups and the functional groups (V-b) are selected from carboxylic acids;
the functional groups (I-a) are selected from thiol functional groups and the functional groups (V-b) are selected from carbon-carbon double bond, carboxylic acid functional groups, or isocyanato;
the functional groups (I-a) are selected from hydroxylamine and the functional groups (V-b) are selected from aldehyde;
the functional groups (I-a) are selected from oxazolino and the functional groups (V-b) are selected from carboxylic acid;
the functional groups (I-a) are selected from aziridino and the functional groups (V-b) are selected from carboxylic acid or hydroxyl;
the functional groups (I-a) are selected from imino and the functional groups (V-b) are selected from carboxylic acid;
the functional groups (I-a) are selected from carbodiimino and the functional groups (V-b) are selected from carboxylic acid;
the functional groups (I-a) are selected from glycol groups and the functional groups (V-b) are selected from carboxylic acid functional groups;
the functional groups (I-a) are selected from hydrazido and the functional groups (V-b) are selected from aldehyde;
the functional groups (I-a) are selected from aldehyde and the functional groups (V-b) are selected from hydroxyl, acetoacetyl, hydroxylamine, or hydrazido;
the functional groups (I-a) are selected from ketone and the functional groups (V-b) are selected from hydroxy.

Preferably, the bond formed by the reaction of the functional groups (i-a) on the latex polymer (I) and the functional groups (V-b) of the silane compound (V) is thermally reversible.

### Silane Compound (III) Comprising One Terminal Silane Functional Group (III-a) and at Least One Additional Functional Group (III-b):

According to the present invention, any silane compound (III) can be used that comprises one terminal silane functional group (III-a) and at least one additional functional group (III-b) capable to form a thermally reversible bond (III-c) with the functional group (I-a) of the latex polymer (I). The silane compound (III) may ensure that the elastomeric film of the final dip-molded article exhibits the desired mechanical properties even if no sulfur vulcanization is used.

The thermally reversible bond (III-c) may be selected from the group consisting of disulfide, tetrasulfide, carbonate, urea, thiourea, ester, beta-hydroxy ester, thioester, beta-hydroxy amine, beta-hydroxy thioether, amide, urethane, enamine, imine, hemiacetal, acetal, hemiketal, ketal, boronate ester, siloxane, oxime, acylhydrazone, aldol, thiuram disulfide and trithiocarbonate.

According to the present invention, the silane compound (III) may have the structural formula:

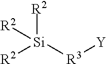

wherein R² is independently selected from hydrogen, halogen, hydroxyl, alkoxy, hydrocarbyl or mixtures thereof; R³ is linear or branched C₁-C₂₀ alkanediyl, cyclic C₃-C₂₀ alkyl or alkenyl, or arylenediyl, preferably linear C₁-C₂₀ alkanediyl; and Y is the functional group (III-b).

The functional group (III-b) preferably may be selected from the group consisting of epoxy, thiol, hydroxy, hydroxylamine, primary or secondary amino, isocyanato, oxazolino, aziridino, imino, carbodiimido, glycol, ester, acetoxy, carboxyl acid, dioxolanone, hydrazido, aldehyde, ketone and combinations thereof. The functional group (III-b) of the silane compound (III) may be blocked as described above.

Suitable silane compounds (III) may be selected from (3-glycidyloxypropyl) trialkoxysilane, beta-(3,4-epoxycyclohexylethyl trialkoxysilane), dialkoxy (3-glycidyloxypropyl)alkylsilane, 3-glycidoxypropyldialkylalkoxysilane, 5,6-epoxyhexyltrialkoxysilane, amino propyl trialkoxysilane, hydroxymethyltrialkoxysilane, 3-mercaptopropyltrialkoxysilane, 3-chloropropyltrialkoxysilane, vinyltrialkoxysilane, 3-(trialkoxysilyl)furan, norbonenyltrialkoxysilane, carboxyethyl silanetriol, 3-isocyanatopropyltrialkoxysilane, tris[3-(trialkoxysilyl)propyl] isocyanurate, trialkoxysilyl butyraldehyde, ureidopropyltrialkoxysilane, cyanomethyl [3-(trialkoxysilyl)propyl] trithiocarbonate, S-(octanoyl) mercaptopropyl trialkoxysilane and combinations thereof. Preferably, the alkoxy group is selected from a methoxy group, and an ethoxy group, more preferably from an ethoxy group.

Preferably, the silane compound (III) may be selected from (3-glycidyloxypropyl) trimethoxysilane, (3-glycidyloxypropyl) triethoxysilane, beta-(3,4-epoxycyclohexylethyl trimethoxysilane), diethoxy (3-glycidyloxypropyl)methylsilane, 3-glycidoxypropyldimethylethoxysilane, 5,6-epoxyhexyltriethoxysilane, amino propyl triethoxysilane, hydroxymethyltriethoxysilane, 3-mercaptopropyltriethoxysilane, 3-chloropropyltrimethoxysilane, vinyltriethoxysilane, 3-(triethoxysilyl)furan, norbonenyltriethoxysilane, carboxyethyl silanetriol, 3-isocyanatopropyltriethoxysilane, tris[3-(trimethoxysilyl)propyl] isocyanurate, triethoxysilyl butyraldehyde, ureidopropyltrimethoxysilane, cyanomethyl [3-(trimethoxysilyl)propyl]trithiocarbonate, S-(octanoyl) mercaptopropyl triethoxysilane and combinations thereof.

The polymer latex composition of the present invention may comprise 80 to 99.9 wt.-%, preferably 85 to 99.9 wt.-%, more preferred 90 to 99.9 wt.-%, even more preferred 92 to 99.8 wt.-% and most preferred 95 to 99.8 wt.-% of the latex polymer (I), based on the total weight of the particles of a latex polymer (I) and the silane compound(s) of the invention described herein. Thus, the lower limit for the amount of particles of latex polymer (I) may be 80 wt.-%, or 82 wt.-%, or 85 wt.-%, or 86 wt.-%, or 88 wt.-%, or 90 wt.-%, or 92 wt.-%, or 94 wt.-%, or 95 wt.-% based on the total weight of the particles of a latex polymer (I) and the silane compound(s) of the invention described herein. The upper limit for the amount of particles of latex polymer (I) may be 99.9 wt.-%, or 99.8 wt.-%, or 99.5 wt.-%, or 99.2 wt.-%, or 99 wt.-%, or 98 wt.-%, or 97 wt.-%, or 96 wt.-%, based on the total weight of the particles of a latex polymer (I) and the silane compound(s) of the invention described herein. The polymer latex composition of the present invention may comprise 0.1 to 20 wt.-%, preferably 0.1 to 18 wt.-%, more preferred 0.1 to 15 wt.-%, even more preferred 0.1 to 12 wt.-%, most preferred 0.1 to 10 wt.-% of the silane compound (III), based on the total weight of the particles of a latex polymer (I) and the silane compound(s) of the invention described herein. The lower limit for the amount of the silane compound (III) may be 0.1 wt.-%, or 0.2 wt.-%, or 0.3 wt.-%, or 0.4 wt.-%, or 0.5 wt.-% or 0.6 wt.-%, or 0.8 wt.-%, or 1 wt.-%, or 1.5 wt.-%, or 2 wt.-%, or 2.5 wt.-%, or 3 wt.-%, based on the total weight of the particles of a latex polymer (I), and the silane compound(s) of the invention described herein. The upper limit for the amount of silane compound (III) may be 20 wt.-%, or 18 wt.-%, or 15 wt.-%, or 14 wt.-%, or 12 wt.-%, or 10 wt.-%, or 9 wt.-%, or 8 wt.-% or 5 wt.-%, based on the total weight of the particles of a latex polymer (I), and the silane compound(s) of the invention described herein. A person skilled in the art will understand that any range formed by any of the explicitly disclosed lower limits and upper limits is explicitly disclosed in the present specification.

According to the present invention latex polymer (I) is prepared by aqueous emulsion polymerization as described above. To the obtained polymer latex comprising particles of latex polymer (I) the silane compound (II) or the silane compound (III) is added at any suitable stage prior to forming for example an article comprising an elastomeric film from the polymer latex of the present invention. For example, silane compound (II) or silane compound (III) may be added to the polymer latex comprising latex polymer (I) prior or after compounding to a dip-molding composition. The same applies for the silane compound (V). To the obtained polymer latex comprising particles of latex polymer the silane compound (V) can be added at any suitable stage prior to forming for example an article comprising an elastomeric film from the polymer latex of the present invention, as well as before or after adding the silane compound (II).

The functional groups (I-a) on the latex polymer (I) and functional groups (III-b) of the silane compound (III) may be selected to provide the combinations described above for the combinations of the functional group (I-a) on the latex polymer (I) and the functional groups (V-b) of the silane compound (V).

The polymer latex composition of the present invention may further comprise polyvalent cations. Suitable polyvalent cations may be metal oxides, such as zinc oxide, magnesium oxide or iron oxide.

### Preparation of the Latex Composition

The present invention further relates to a method for preparation of a polymer latex composition of the present invention. The method comprises polymerizing in an emulsion polymerization process a composition comprising ethylenically unsaturated monomers for latex polymer (I) comprising at least one monomer resulting after polymerization in a functional group (I-a) to obtain a latex comprising particles of latex polymer (I) comprising functional groups (I-a); and adding a silane compound (II) comprising at least two terminal silane functional groups (II-a) and a thermally reversible bond (II-b) or adding a silane compound (III) comprising (III-a) one terminal silane functional group and (III-b) at least one additional functional group capable to form a thermally reversible bond (III-c) with the functional group (I-a) of the latex polymer (I).

Optionally, a compound (V) comprising one terminal silane functional groups (V-a) and at least one additional functional group (V-b) reactive with the functional groups (I-a) of the particles of the latex polymer (I) may be added before, during or after the addition of the silane compound (II). All variations with respect to the latex polymer (I), silane compound (II), silane compound (III), silane compound (IV), silane compound (V) and their relative amounts as described above can be used.

### Compounded Latex Composition for the Production of Dip-Molded Articles:

The polymer latex composition of the present invention is particularly suitable for dip-molding processes. Therefore, according to one aspect of the present invention the polymer latex composition is compounded to produce a curable polymer latex compound composition that can be directly used in dip-molding processes. To get reproducible good physical film properties, it is advisable to adjust the pH of the compounded polymer latex composition by pH modifiers to be in the range of pH 7 to 11, preferably 8 to 10, more preferred 9 to 10, for dipping to produce thin disposable gloves. For producing unsupported and/or supported reusable gloves, it is advisable to adjust the pH of the compounded polymer latex composition by pH modifiers to be in the range of pH 8 to 10, preferably 8.5 to 9.5. The compounded polymer latex composition contains the polymer latex composition of the present invention, optionally pH modifiers, preferably ammonia or alkali hydroxides and optionally usual additives to be used in these compositions selected from antioxidants, pigments, TiO₂, fillers, such as silica-based fillers, and dispersing agents. Suitable silica-based fillers include fumed silica and precipitated silica.

Alternatively, instead of compounding the polymer latex composition of the present invention also a polymer latex comprising the latex polymer (I) as defined above may be compounded in the same way as described above and during or after the compounding step silane compound (II) as defined above or silane compound (III) as defined above can be added to provide the compounded latex composition of the present invention. Additionally, silane compound (V) as defined above can be added during or after the compounding of the latex polymer composition comprising the polymer latex (I) and the silane compound (II). Of course, all variations with respect to the latex polymer (I), silane compound (II), silane compound (III), silane compound (IV), silane compound (V) and their relative amounts as described above can be used.

It is possible to add conventional vulcanization systems to the compounded polymer latex composition according to the present invention to be used in dip-molding processes, such as sulfur in combination with accelerators, such as thiurams and carbamates and zinc oxide to make it curable. Alternatively, or additionally, a crosslinker component like, for example, polyvalent cations or other polyfunctional organic compounds suitable to react with functional groups on the latex particles in order to achieve chemical crosslinking may be added. Preferably, polyvalent cations and/or silica-based fillers can be added to the latex composition according to the present invention. Suitable polyvalent cations include metal oxides, preferably zinc oxide, magnesium oxide, iron oxides.

However, it is a particular advantage of the present invention that the compounded latex composition of the present invention can be free of sulfur vulcanization agents and accelerators for sulfur vulcanization, and the polymer latex compound of the present invention is still curable to provide dip-molded articles having the required tensile properties. It is preferred to use polyvalent cations for example ZnO as additional crosslinker component to appropriately adjust the mechanical properties in particular of very thin elastomeric films having a film thickness of 0.1 mm at most, preferably of 0.01 to 0.1 mm, more preferred 0.03 to 0.08 mm.

Suitably, the polyvalent cations may be present in amounts up to 20 wt.-%, based on the total weight of the particles of the latex polymer (I), the silane compound (II) or the silane compound (III), and if present the silane compound (V).

In certain heavy duty applications like industrial gloves it might be advantageous to employ, in addition to the self-crosslinking properties of the polymer latex of the present invention, conventional sulfur vulcanization systems as described above in order to further increase the mechanical strength of the dip-molded articles.

### Method for Making Dip-Molded Articles:

In a suitable method for making dip-molded latex articles, first, a mold having the desired shape of the final article is immersed in a coagulant bath comprising a solution of a metal salt. The coagulant is usually used as a solution in water, an alcohol or a mixture thereof. As specific examples of the coagulant the metal salts can be metal halides like calcium chloride, magnesium chloride, barium chloride, zinc chloride and aluminum chloride; metal nitrates such as calcium nitrate, barium nitrate and zinc nitrate; metal sulfates like calcium sulfate, magnesium sulfate, and aluminum sulfate; and acetic acid salts such as calcium acetate, barium acetate and zinc acetate. Most preferred are calcium chloride and calcium nitrate. The coagulant solution might contain additives to improve the wetting behavior of the former.

Thereafter, the mold is removed from the bath and optionally dried. The such treated mold is then immersed in the compounded latex composition according to the present invention. Thereby, a thin film of latex is coagulated on the surface of the mold. Alternatively, it is also possible to obtain the latex film by a plurality of dipping steps, particularly two dipping steps in sequence.

Thereafter, the mold is removed from the latex composition and optionally immersed in a water bath in order to extract, for example, polar components from the composition and to wash the coagulated latex film.

Thereafter, the latex coated mold is optionally dried, preferably at temperatures below 80° C.

Finally, the latex coated mold is heat-treated at a temperature of 40 to 180° C., such as at temperatures of 40 to 160° C., or 40 to 150° C., or 40 to 130° C. and/or exposed to UV radiation in order to obtain the desired mechanical properties for the final film product. Then, the final latex film is removed from the mold. The duration of the heat treatment will depend on the temperature and is typically between 1 and 60 minutes. The higher the temperature, the shorter is the required treatment time.

As an alternative a cut and seal process may be used. In a first step continuous elastomeric films of the polymer latex are made for example by a casting process and optional curing by heating and/or UV curing. In a next stage two separate continuous elastomeric films are aligned and there is then cutting/stamping of the aligned continuous elastomeric films into a preselected shape to obtain two superposed layers of the elastomeric films in the preselected shape. The superposed layers of elastomeric film are joined together at least in a preselected part of the periphery of the superposed layers to form an elastomeric article. The joining together may be performed by using thermal means, preferably selected from heat sealing and welding or by gluing or a combination of heating and gluing.

The present invention relates to articles made by using the polymer latex composition of the present invention or the compounded latex composition of the present invention.

The present invention is especially applicable for latex articles selected from health care devices, like surgical gloves, examination gloves, condoms, catheters, balloons, tubing, dental dam and apron or all different kinds of industrial and household gloves.

Furthermore, the polymer latex of the present invention can also be used for the coating and impregnation of substrates, preferably textile substrates. Suitable products obtained thereby are textile-supported gloves and preformed gaskets.

The present invention will be further illustrated with reference to the following examples.

### EXAMPLES

The following abbreviations are used in the Examples:
MAA=methacrylic acid
Bd=butadiene
ACN=acrylonitrile
GMA=glycidyl methacrylate
tDDM=tert-dodecyl mercaptan
Na₄EDTA=tetra sodium salt of ethylenediaminetetraacetic acid
ZnO=zinc oxide
TiO₂=titanium dioxide
TS=tensile strength
EB=elongation at break
FAB=force at break

In the following all parts and percentages are based on weight unless otherwise specified.

### Example 1: Preparation of Latex A

2 parts by weight (based on polymer solids) of an oxirane-free seed latex (average particle size 36 nm) and 80 parts by weight of water (based on 100 parts by weight of monomer including the seed latex) were added to a nitrogen-purged autoclave and subsequently heated to 30° C. Then 0.01 parts by weight of Na₄EDTA and 0.005 parts by weight of Bruggolite FF6 dissolved in 2 parts by weight of water were added, followed by 0.08 parts by weight of sodium persulfate dissolved in 2 parts by weight of water. Then, the monomers (35 parts by weight of ACN, 58 parts by weight of Bd, 5 parts by weight of MAA), and were added together with 0.6 parts by weight of tDDM over a period of 4 hours. Over a period of 10 hours 2.2 parts by weight of sodium dodecyl benzene sulfonate, 0.2 parts by weight of tetra sodium pyrophosphate and 22 parts by weight of water were added. The co-activator feed of 0.13 parts by weight of Bruggolite FF6 in 8 parts by weight of water was added over 9 hours. The temperature was maintained at 30° C. up to a conversion of 95%, resulting in a total solids content of 45%. The polymerization was short-stopped by addition of 0.08 parts by weight of a 5% aqueous solution of diethylhydroxylamine. The pH was adjusted using potassium hydroxide (5% aqueous solution) to pH 7.0 and the residual monomers were removed by vacuum distillation at 60° C. 0.5 parts by weight of a Wingstay L type antioxidant (60% dispersion in water) was added to the raw latex, and the pH was adjusted to 8.0 by addition of a 5% aqueous solution of potassium hydroxide.

### Example 2: Preparation of Latex B

A nitrogen-purged autoclave was charged with 2.0 parts by weight of diphenyl oxide disulfonate dissolved in 185 parts by weight of water relative to 100 parts by weight monomer and heated to a temperature of 70° C. 0.1 parts by weight of tDDM and 0.05 parts by weight of Na₄EDTA were added to the initial charge, together with 0.7 parts by weight of ammonium peroxodisulfate (12% solution in water) added in an aliquot addition. Then 45.4 parts by weight of Bd, 14.6 parts by weight of ACN and a solution of 5.0 parts by weight of diphenyl oxide disulfonate dissolved in 50 parts by weight of water were added over a period of 6.5 hours. The addition of 40 parts by weight of GMA was started after 1 hour and added over a period of 6.5 hours. After the addition of the monomers the temperature was maintained at 70° C. The polymerization was maintained up to a conversion of 99%. The reaction mixture was cooled to room temperature and sieved through a filter screen (90 μm).

### Preparation of Dipping Latex Examples

### Latex Compounding and Maturation

Commercially available XNBR grade latices from Synthomer Sdn. Bhd (Malaysia) were used throughout the dipping examples. Latex formulation examples were compounded by addition into the latex in accordance to Table 1 and 2 in parts per hundred rubber (phr) while continuously stirred. The accelerator used is zinc diethyldithiocarbamate. Additive A1 is (3-glycidyloxypropyl) trimethoxysilane, while Additive A2 is bis[3-(triethoxysilyl)propyl] disulfide and Additive A3 is bis[3-(triethoxysilyl)propyl] tetrasulfide. The compounded latex under stirring was then pH adjusted to pH 10.0 by adding of a 5% potassium hydroxide solution in water, diluted to a total solid content of 18% and matured under continuous stirring at 25° C. for at least 16 hours.

### Spade Dipping

Spade dipping was conducted manually or using automatic dipping machine. A dipping plate mold was conditioned in an air circulated oven at 70° C., then dipped into a coagulant solution comprising of 18-20 wt. % aqueous solution of calcium nitrate and 2-3 wt. % of calcium carbonate at 60° C. for 1 second. The dipping plate mold was then placed in an oven set at 75-85° C. for a certain time then dipped into respective latices at dipping plate mold temperature of 60-65° C. for a set time to obtain a latex-dipped plate mold. The latex-dipped plate mold was then gelled in the oven for 1 minute at 100° C., leached into deionized water leaching tank for 1 minute at 50-60° C. followed by curing in the oven at 120° C. for 20 minutes. Finally, a cured latex was manually stripped from the plate mold. The cured latices were conditioned in the climate room at 23° C. (±2) at 50% (±5) relative humidity for at least 16 hours before other physical tests.

### Former Dipping

Dipping was conducted manually or using automatic dipping machine. A liner glove was fitted to a former and the former was conditioned in an air circulated oven at 70° C., then dipped into a coagulant solution comprising of 18-20 wt. % aqueous solution of calcium nitrate and 2-3 wt. % of calcium carbonate at 60° C. for 1 second. The former was then placed in an oven set at 75-85° C. for a certain time then dipped into respective latices at former temperature of 60-65° C. for a set time, withdrawn and kept turning to avoid formation of liquid droplets to obtain a latex-dipped former. The latex-dipped former was then gelled in the oven for 1 minute at 100° C., film-beaded and leached into deionized water leaching tank for 1 minute at 50-60° C. followed by curing in the oven at 120° C. for 20 minutes. Finally, a cured latex glove was manually stripped from the former. The gloves were conditioned in the climate room at 23° C. (±2) at 50% (±5) relative humidity for at least 16 hours before other physical tests.

### Determination of Tensile Properties (ASTM D6319 and EN 455)

The tensile properties of the final gloves or films were tested according to ASTM D6319 and EN455 test procedures. Dumbbell specimens were cut from palm area of gloves or films prepared from each latex compound. The unaged and aged samples (“aged” refers to specimens which are placed in an oven for 22 hours at 100° C. before tensile properties are tested) were conditioned at 23 t 2° C. and 50 t 5% relative humidity for 24 hours prior to testing on the extensometer. The film thickness (mm) was measured with a typical film thickness value between 0.060-0.070 mm. The reported tensile strength (TS) corresponds to the determined maximum tensile stress in stretching the specimen to rupture. The elongation at break (EB) corresponds to the elongation at which rupture occurs. The force at break (FAB) corresponds to the force at which rupture occurs. While Modulus 100, 300 and 500 corresponds to the determined tensile stress in stretching the specimen at 100, 300 and 500% elongation.

### Stress Relaxation Time

The stress relaxation time experiments were performed under strain control at a specified temperature (115° C., 135° C. and 155° C.) via tensile mode using DMA Q800 instrument. The film samples measuring approximately 20 mm×6 mm×0.06 mm were mounted onto tensile clamp with static force of less than 0.01 N. After which the axial force was then adjusted to 0 N and instrument's chamber heated to at least 95% of the target temperature within 3 min and allowed to equilibrate at the target temperature for approximately 5 min. Each sample was then subjected to an instantaneous 2% strain. The stress decay was monitored for at least 20 min, while maintaining a constant strain. The time taken for stress decay to reach 1/e of its initial value is the stress relaxation time.

### Determination of Durability

The former dipped gloves to be tested were cut using scissors in a straight line from the crotch between index and middle finger to the cuff line below the thumb. The thumb and finger sample cut was kept along the outside edge to a point at the tip of the thumb. The sample was opened, and the tip of the index finger was attached into the top jaws of the automated stress and relaxation equipment and the clamp was shut. The lower area of the sample was attached between the jaws at the lower clamp and the clamp was shut. The free “wing” of the sample was attached to the sidebars of the test equipment by using masking tape. The test equipment was positioned into the beaker containing the aqueous citric acid solution at pH 4 so that the crotch between the thumb and index finger was fully immersed in the aqueous acid solution. The test equipment was set to zero (0) and the test was started. The test was conducted at 25° C. The measurement stopped automatically when the sample broke and the number of cycles required to reach break point were recorded. The test was repeated 5 times to allow an average to be calculated, whereby fresh aqueous citric acid solution was used for each test. The reported durability (in minutes) corresponds to the average number of cycles (average number of cycles required to cause the sample failure) divided by 267 (total cycle per hour) and multiplied by 60. The test was stopped after 300 min or until failure. The fatigue durability is preferably 60 minutes or more. The Performance Level can be categorized as Fail if less than 60 min; Low from 60 to 120 min, Moderate from 120-240 min; or Good if more than 240 min.

In Table 1 (Examples 1 to 9 and comparative example CE 1) the latex compounding formulations and maturation for spade dipping are shown:

TABLE 1
Latex compounding formulations and maturation for spade dipping

| Parts (phr) | Ex. 1 | Ex. 2 | Ex. 3 | Ex. 4 | Ex. 5 | Ex. 6 | Ex. 7 | Ex. 8 | Ex. 9 | CE 1 |
|---|---|---|---|---|---|---|---|---|---|---|
| Latex A | 100 | 100 | 100 | 100 | 100 | 100 | 100 | 100 | 100 | 100 |
| ZnO | 1.0 | 1.0 | 1.0 | 1.0 | 1.0 | 1.0 | 1.0 | 1.0 | 1.0 | 1.0 |
| TiO₂ | 1.0 | 1.0 | 1.0 | 1.0 | 1.0 | 1.0 | 1.0 | 1.0 | 1.0 | 1.0 |
| Sulphur | — | — | — | — | — | — | — | — | — | 0.8 |
| Accelerator | — | — | — | — | — | — | — | — | — | 0.7 |
| Additive A1 | 0.35 | — | 0.35 | 0.35 | 0.35 | 0.35 | — | 0.70 | 0.70 | — |
| Additive A2 | — | 0.35 | 0.35 | — | 0.70 | 1.05 | 0.70 | — | 0.70 | — |
| Additive A3 | — | — | — | 0.35 | — | — | — | — | — | — |

In Table 2 (Examples 10 to 15 and comparative example 2) the latex compounding formulations and maturation for former dipping are shown.

TABLE 2
Latex compounding formulations and maturation for former dipping

| Parts (phr) | Ex. 10 | Ex. 11 | Ex. 12 | Ex. 13 | Ex. 14 | Ex. 15 | CE 2 |
|---|---|---|---|---|---|---|---|
| Latex A | 100 | 100 | 100 | 100 | 100 | 100 | 90 |
| Latex B | — | — | — | — | — | — | 10 |
| ZnO | 1.0 | 1.0 | 1.0 | 1.0 | 1.0 | 1.0 | 1.0 |
| TiO₂ | 1.0 | 1.0 | 1.0 | 1.0 | 1.0 | 1.0 | 1.0 |
| Sulphur | — | — | — | — | — | — | — |
| Accelerator | — | — | — | — | — | — | — |
| Additive A1 | 0.70 | — | 0.35 | 0.70 | 0.70 | — | — |
| Additive A2 | — | 0.70 | 0.35 | 0.35 | 0.70 | — | — |
| Additive A3 | — | — | — | — | — | 0.8 | — |

The tensile data for the as-prepared films described above were measured and summarized in Tables 3 to 6.

TABLE 3
Unaged results for Ex. 1 to 9 and CE 1

| | ASTM D6319 | | | | | | EN 455 | |
|---|---|---|---|---|---|---|---|---|
| | Thick- | | | | | | Thick- | |
| | ness | TS | EB | Modulus | | | ness | FAB |
| Sample | (mm) | (MPa) | (%) | 100 | 300 | 500 | (mm) | (N) |
| CE 1 | 0.066 | 26.0 | 590 | 1.9 | 3.8 | 10.4 | 0.065 | 7.2 |
| Ex. 1 | 0.068 | 26.2 | 585 | 2.1 | 4.3 | 11.7 | 0.067 | 7.3 |
| Ex. 2 | 0.068 | 24.1 | 592 | 1.9 | 3.9 | 10.4 | 0.067 | 7.5 |
| Ex. 3 | 0.064 | 28.4 | 598 | 2.3 | 4.6 | 11.7 | 0.066 | 7.3 |
| Ex. 4 | 0.067 | 23.6 | 592 | 2.0 | 3.9 | 10.3 | 0.068 | 7.0 |
| Ex. 5 | 0.068 | 26.0 | 639 | 1.8 | 3.5 | 8.0 | 0.065 | 6.3 |
| Ex. 6 | 0.065 | 25.4 | 630 | 1.9 | 3.6 | 8.6 | 0.065 | 6.5 |
| Ex. 7 | 0.069 | 26.6 | 600 | 1.9 | 3.9 | 10.2 | 0.067 | 7.3 |
| Ex. 8 | 0.064 | 25.3 | 565 | 2.1 | 4.6 | 13.4 | 0.066 | 7.4 |
| Ex. 9 | 0.068 | 27.3 | 608 | 2.1 | 4.2 | 10.6 | 0.066 | 6.2 |

TABLE 4
Aged results for Ex. 1 to 9 and CE 1

| | ASTM D6319 | | | | | | EN 455 | |
|---|---|---|---|---|---|---|---|---|
| | Thick- | | | | | | Thick- | |
| | ness | TS | EB | Modulus | | | ness | FAB |
| Sample | (mm) | (MPa) | (%) | 100 | 300 | 500 | (mm) | (N) |
| CE 1 | 0.071 | 32.7 | 534 | 2.4 | 5.8 | 21.8 | 0.064 | 8.1 |
| Ex. 1 | 0.070 | 34.9 | 562 | 2.6 | 6.0 | 19.5 | 0.068 | 8.6 |
| Ex. 2 | 0.067 | 37.7 | 578 | 2.5 | 5.7 | 18.4 | 0.066 | 9.0 |
| Ex. 3 | 0.067 | 37.8 | 582 | 2.5 | 6.1 | 18.2 | 0.064 | 8.8 |
| Ex. 4 | 0.065 | 35.3 | 617 | 2.2 | 4.5 | 12.2 | 0.067 | 8.3 |
| Ex. 5 | 0.068 | 33.0 | 644 | 2.0 | 3.9 | 9.6 | 0.065 | 8.3 |
| Ex. 6 | 0.066 | 34.8 | 621 | 2.2 | 4.5 | 11.8 | 0.066 | 8.3 |
| Ex. 7 | 0.072 | 36.5 | 587 | 2.3 | 5.3 | 16.3 | 0.067 | 8.7 |
| Ex. 8 | 0.067 | 36.0 | 561 | 2.5 | 5.9 | 20.6 | 0.061 | 7.8 |
| Ex. 9 | 0.067 | 35.3 | 621 | 2.2 | 4.7 | 12.2 | 0.066 | 8.3 |

Comparative Examples (CE 1) is a conventional sulphur and accelerator cured latex. As shown in Table 3 (unaged samples), the tensile properties of all samples containing silanes (Ex. 1-9) are comparable to CE 1. For aged samples shown in Table 4, all samples containing silanes (Ex. 1-9) are softer, i.e., lower Modulus 500 (M500), with higher tensile strength (TS) and higher elongation at break (EB) in comparison to CE 1.

Ex. 1 and 8 showed the example of using Additive A1 alone; while Ex. 2 and 7 showed the example of using Additive A2 alone. Both silanes when used with increasing content (phr) showed comparable tensile properties to CE 1.

When Additive 1 is used in combination with Additive 2 or Additive 3 in a ratio of 1:1 as shown in Ex. 3 and 9, both examples showed a comparable TS and showed improvement in terms of EB and lower M15.

TABLE 5
Unaged results for Ex. 10 to 15 and CE 2

| | ASTM D6319 | | | | | | EN 455 | |
|---|---|---|---|---|---|---|---|---|
| | Thick- | | | | | | Thick- | |
| | ness | TS | EB | Modulus | | | ness | FAB |
| Sample | (mm) | (MPa) | (%) | 100 | 300 | 500 | (mm) | (N) |
| CE 2 | 0.061 | 32.7 | 583 | 2.7 | 6.3 | 17.3 | 0.060 | 6.6 |
| Ex. 10 | 0.063 | 32.0 | 656 | 2.1 | 3.8 | 8.6 | 0.061 | 7.1 |
| Ex. 11 | 0.063 | 35.1 | 671 | 2.1 | 3.8 | 8.2 | 0.061 | 7.8 |
| Ex. 12 | 0.062 | 32.4 | 665 | 2.0 | 3.6 | 7.9 | 0.061 | 7.3 |
| Ex. 13 | 0.061 | 36.2 | 603 | 2.7 | 5.6 | 14.5 | 0.060 | 7.3 |
| Ex. 14 | 0.062 | 33.9 | 615 | 2.5 | 5.1 | 12.4 | 0.062 | 7.5 |
| Ex. 15 | 0.058 | 37.3 | 547 | 3.5 | 8.3 | 27.1 | 0.056 | 7.7 |

TABLE 6
Aged results for Ex. 10 to 14 and CE 2

| | ASTM D6319 | | | | | | EN 455 | |
|---|---|---|---|---|---|---|---|---|
| | Thick- | | | | | | Thick- | |
| | ness | TS | EB | Modulus | | | ness | FAB |
| Sample | (mm) | (MPa) | (%) | 100 | 300 | 500 | (mm) | (N) |
| CE 2 | 0.064 | 39.2 | 548 | 3.2 | 8.9 | 29.2 | 0.061 | 8.3 |
| Ex. 10 | 0.066 | 40.9 | 647 | 2.2 | 4.2 | 10.5 | 0.062 | 8.8 |
| Ex. 11 | 0.066 | 39.8 | 683 | 2.0 | 3.5 | 7.8 | 0.062 | 9.3 |
| Ex. 12 | 0.066 | 43.2 | 661 | 2.1 | 4.0 | 9.8 | 0.062 | 8.7 |
| Ex. 13 | 0.063 | 39.5 | 629 | 2.5 | 5.0 | 12.8 | 0.061 | 8.9 |
| Ex. 14 | 0.066 | 41.2 | 616 | 2.5 | 5.3 | 14.3 | 0.061 | 9.1 |
| Ex. 15 | 0.059 | 40.6 | 555 | 3.4 | 8.1 | 27.7 | 0.062 | 8.8 |

CE 2 uses an accelerator-free latex formulation. As shown in Table 5 (unaged samples), the tensile properties of all samples containing silanes (Ex. 10-15) are comparable to CE 2. Similar behavior for aged samples is observed as shown in Table 6, whereby all samples containing silanes (Ex. 10-15) are softer and have higher EB. The use of compound (II) alone as shown in Ex. 11, has a comparable tensile strength but gave the highest EB and softest feature

The relaxation time (τ*) for the as-prepared films described above were measured and summarized in Tables 7.

TABLE 7
Stress relaxation time of samples from spade dipping

| | Stress relaxation time (seconds) | | |
|---|---|---|---|
| Sample | 115° C. | 135° C. | 155° C. |
| Ex. 1 | 30 | 12 | 6 |
| Ex. 2 | 26 | 8 | 4 |
| Ex. 3 | 21 | 8 | 3 |
| Ex. 4 | 17 | 5 | 4 |
| Ex. 7 | 33 | 12 | 7 |
| Ex. 8 | 27 | 8 | 5 |
| Ex. 9 | 24 | 7 | 3 |
| CE 1 | 47 | 25 | 18 |

Stress relaxation time (τ*) is the time required for a latex polymer to relieve its stress under constant strain at a given temperature. A faster (or shorter) τ* is an indication that the stability of the polymer network of crosslinking and entanglement is lower.

As shown in Table 7, the stress relaxation time of the Ex. 1-4 and Ex. 7-9 all have faster stress relaxation time in comparison to CE 1. At the same time, the tensile performance of the Ex. 1-4 and Ex. 7-9 are maintained. Samples comprising Additive A1 in combination with Additive A2 or Additive A3 show the fastest stress relaxation times.

The durability results for the as-prepared films described above were measured and summarized in Tables 8.

TABLE 8
Durability results of Ex. 10 to 15 and CE2

| Sample | Durability (min) | Performance Level |
|---|---|---|
| CE 2 | 263 | Good |
| Ex. 10 | 259 | Good |
| Ex. 11 | 168 | Moderate |
| Ex. 12 | 185 | Moderate |
| Ex. 13 | 255 | Good |
| Ex. 14 | 248 | Good |
| Ex. 15 | 96 | Low |

From the durability results as shown in Table 8, for Ex. 10, 13 and 14, the addition of 0.7 phr of Additive A1 gave good durability. The use of Additive A2 does not reduce the durability performance. When Additive A1 is used alone or in combination with Additive A2, similar performance to an accelerator-free latex formulation (CE 2) are achieved. Surprisingly, the use of Additive A2 when used alone (Ex. 11) has a moderate level of durability performance. The use of Additive A3 alone has a low but higher than the preferable 60 min durability time.

1. A polymer latex composition for the preparation of elastomeric films comprising:
(I) particles of a latex polymer obtained by free-radical emulsion polymerization of a composition comprising ethylenically unsaturated monomers, the latex polymer comprising (I-a) a functional group; and
(II) a silane compound comprising (II-a) at least two terminal silane functional groups and (II-b) a thermally reversible bond; or
(III) a silane compound comprising (III-a) one terminal silane functional group and (III-b) at least one additional functional group capable to form a thermally reversible bond (III-c) with the functional group (I-a) of the latex polymer (I).

2. The polymer latex composition according to claim 1, wherein the thermally reversible bond (II-b) or (III-c) is capable to disrupt and rearrange at a temperature of or less than 200° C.; and/or
wherein the thermally reversible bond (II-b) or (III-c) is selected from the group consisting of disulfide, tetrasulfide, carbonate, urea, thiourea, ester, beta-hydroxy ester, thioester, beta-hydroxy amine, beta-hydroxy thioether, amide, urethane, enamine, imine, hemiacetal, acetal, hemiketal, ketal, boronate ester, siloxane, oxime, acylhydrazone, aldol, thiuram disulfide and trithiocarbonate; and/or
wherein the functional groups (I-a) of the particles of the latex polymer (I) are selected from the group consisting of carbon-carbon double bond, carboxylic acid, hydroxy, epoxy, acetoacetyl, primary or secondary amino, acetoxy, isocyanato, alkoxy, dioxolanone, halide functional group, thiol, hydroxylamine, oxazolino, aziridino, imino, carbodiimido, glycol, ester, hydrazido, aldehyde, ketone and combinations thereof.

3. The polymer latex composition according to claim 1, wherein the silane compound (II) has the structural formula: 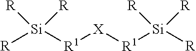
wherein X is the thermally reversible bond (II-b);
R is independently selected from hydrogen, halogen, hydroxyl, alkoxy, hydrocarbyl, silane or mixtures thereof; and
R¹ independently is linear or branched C₁-C₂₀ alkanediyl, cyclic C₃-C₂₀ alkyl or alkenyl, or arylenediyl; and/or
wherein the silane compound (II) is selected from the group consisting of bis[3-(trialkoxysilylpropyl)] disulfide, bis[3-(trialkoxysilyl)propyl] tetrasulfide, bis[3-(trialkoxysilyl)propyl] carbonate, N,N′-bis[3-(trialkoxysilyl)propyl] urea, N,N′-bis[3-(trialkoxysilyl)propyl] thiourea, 2-hydroxy-3-[3-(trialkoxysilyl)propoxy]propyl 3-(trihydroxysilyl)propanoate, 2-hydroxy-7-(trialkoxysilyl)heptyl 3-(trihydroxysilyl)propanoate, 9,9-dialkoxy-1,1,1-trihydroxy-10-oxa-5-thia-1,9-disiladodecan-4-one, N-[3-(trialkoxysilyl)propyl]-3-(trihydroxysilyl)propenamide, (trialkoxysilyl)methyl N-[3-(trialkoxysilyl)propyl]carbamate, (7E)-4,4,12,12-tetraalkoxy-3,13-dioxa-8-aza-4,12-disilapentadec-7-ene, 4,4,11,11-tetraalkoxy-3,6,12-trioxa-4,11-disilatetradecan-7-ol, 4,4,10,10-tetraalkoxy-7-[3-(trialkoxysilyl)propyl]-3,6,8,11-tetraoxa-4,10-disilatridecane, oligomeric siloxanes and combinations thereof; and/or
wherein the silane compound (II) is formed in situ from (IV) a first silane compound comprising (IV-a) one terminal silane functional group and (IV-b) at least one additional functional group capable to form a thermally reversible bond (IV-c) with the additional functional group (IV-b) of second silane compound (IV).

4. The polymer latex composition according to claim 1, wherein the at least one additional functional group (III-b) of the silane compound; or the at least one additional functional group (IV-b) of the first silane compound (IV) and/or the at least one additional functional group (IV-b) of the second silane compound (IV) is blocked, and/or
wherein the silane compound (III) or the silane compound (IV) has the structural formula: 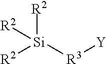
wherein R² is independently selected from hydrogen, halide, hydroxyl, alkoxy, hydrocarbyl or mixtures thereof;
R³ is linear or branched C₁-C₂₀ alkanediyl, cyclic C₃-C₂₀ alkyl or alkenyl, or arylenediyl; and
Y is the functional group (III-b) or (IV-b); and/or
wherein the silane compound (III) or the silane compound (IV) is selected from the group consisting of (3-glycidyloxypropyl) trialkoxysilane, (3-glycidyloxypropyl) trialkoxysilane, beta-(3,4-epoxycyclohexylethyl trialkoxysilane), dialkoxy (3-glycidyloxypropyl)alkylsilane, 3-glycidoxypropyldialkylalkoxysilane, 5,6-epoxyhexyltrialkoxysilane, amino propyl trialkoxysilane, hydroxymethyltrialkoxysilane, 3-mercaptopropyltrialkoxysilane, 3-chloropropyltrialkoxysilane, vinyltrialkoxysilane, 3-(trialkoxysilyl)furan, norbonenyltrialkoxysilane, carboxyethyl silanetriol, 3-isocyanatopropyltrialkoxysilane, tris[3-(trialkoxysilyl)propyl] isocyanurate, trialkoxysilyl butyraldehyde, ureidopropyltrialkoxysilane, cyanomethyl [3-(trialkoxysilyl)propyl]trithiocarbonate, S-(octanoyl)mercaptopropyl trialkoxysilane and combinations thereof.

5. The polymer latex composition according to claim 1, comprising the silane compound (II) and prefer-aby-further comprising a silane compound (V), wherein the silane compound (V) comprises (V-a) one terminal silane functional group and (V-b) at least one additional functional group reactive with the functional group (I-a) of the latex polymer (I), wherein the bond formed by the reaction of the functional groups (I-a) and the functional groups (V-b), and/or
wherein the mass ratio of the silane compound (II) to the silane compound (V) is from 100:1 to 1:100.

6. The polymer latex composition according to claim 5, wherein the functional group (V-b) of the silane compound (V) is selected from the group consisting of carbon-carbon double bond, halide functional group, epoxy, thiol, hydroxy, hydroxylamine, primary or secondary amino, isocyanato, oxazolino, aziridino, imino, carbodiimido, glycol, ester, acetoxy, carboxyl acid, dioxolanone, hydrazido, aldehyde, ketone and combinations thereof; and/or
wherein the silane compound (V) has the structural formula: 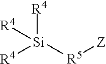
wherein R⁴ is independently selected from hydrogen, halide, hydroxyl, alkoxy, hydrocarbyl or mixtures thereof;
R⁵ is linear or branched C₁-C₂₀ alkanediyl, cyclic C₃-C₂₀ alkyl or alkenyl, or arylenediyl; and
Z is the functional group (V-b) reactive with the functional groups (I-a) of the particles of the latex polymer (I); and/or
wherein the silane compound (V) is selected from the group consisting of (3-glycidyloxypropyl) trialkoxysilane, (3-glycidyloxypropyl) trialkoxysilane, beta-(3,4-epoxycyclohexylethyl trialkoxysilane), dialkoxy (3-glycidyloxypropyl)alkylsilane, 3-glycidoxypropyldialkylethoxysilane, 5,6-epoxyhexyltrialkoxysilane, amino propyl trialkoxysilane, hydroxymethyltrialkoxysilane, 3-mercaptopropyltrialkoxysilane, 3-chloropropyltrialkoxysilane, vinyltrialkoxysilane, 3-(trialkoxysilyl)furan, norbonenyltrialkoxysilane, carboxyethyl silanetriol, 3-isocyanatopropyltrialkoxysilane, tris[3-(trialkoxysilyl)propyl] isocyanurate, trialkoxysilyl butyraldehyde, ureidopropyltrialkoxysilane, cyanomethyl [3-(trialkoxysilyl)propyl]trithiocarbonate, S-(octanoyl)mercaptopropyl trialkoxysilane and combinations thereof.

7. The polymer latex composition according to claim 1, wherein the monomer composition to obtain the particles of a latex polymer (I) comprises:
(i) 15 to 99 wt.-% of conjugated dienes;
(ii) 1 to 80 wt.-% of monomers selected from ethylenically unsaturated nitrile compounds;
(iii) 0 to 10 wt.-% of an ethylenically unsaturated compound different from (i) and (ii) comprising a functional group (a);
(iv) 0 to 80 wt.-% of vinyl aromatic monomers; and
(v) 0 to 65 wt.-% of alkyl esters of ethylenically unsaturated acids;
the weight percentages being based on the total weight of monomers in the monomer composition.

8. The polymer latex composition according to claim 7, wherein
(i) the conjugated dienes are selected from butadiene, isoprene, 2,3-dimethyl-1,3-butadiene, 2-ethyl-1,3-butadiene, 1,3-pentadiene and combinations thereof;
(ii) the ethylenically unsaturated nitrile compounds are selected from (meth)acrylonitrile, alpha-cyanoethyl acrylonitrile, fumaronitrile, alpha-chloronitrile and combinations thereof;
(iii) the ethylenically unsaturated compounds different from (i) and (ii) comprising a functional group (a) are selected from
(iii1) ethylenically unsaturated compounds having at least two different ethylenically unsaturated groups;
(iii2) ethylenically unsaturated acids and salts thereof;
(iii3) hydroxy functional ethylenically unsaturated compounds;
(iii4) oxirane functional ethylenically unsaturated compounds;
(iii5) acetoacetyl functional ethylenically unsaturated compounds;
(iii6) ethylenically unsaturated compounds bearing a primary or secondary amino group;
(iii7) acetoxy functional ethylenically unsaturated compounds;
(iii9) alkoxysilyl functional ethylenically unsaturated compounds;
(iii10) alkoxy functional ethylenically unsaturated compounds;
(iii11) dioxolanone functional ethylenically unsaturated compounds;
(iii12) halide functional ethylenically unsaturated compounds;
(iii13) thiol functional ethylenically unsaturated compounds;
(iii14) hydroxylamine functional ethylenically unsaturated compounds;
(iii15) oxazolino functional ethylenically unsaturated compounds;
(iii16) aziridino functional ethylenically unsaturated compounds;
(iii17) imino functional ethylenically unsaturated compounds;
(iii18) carbodiimino functional ethylenically unsaturated compounds;
(iii19) glycol functional ethylenically unsaturated compounds;
(iii20) hydrazido functional ethylenically unsaturated compounds;
(iii21) aldehyde ether ethylenically unsaturated compounds;
(iii22) ketone functional ethylenically unsaturated compounds;
(iv) the vinyl aromatic monomers are selected from styrene, alpha-methyl styrene and combinations thereof;
(v) alkyl esters of ethylenically unsaturated acids are selected from methyl (meth)acrylate, ethyl (meth)acrylate, propyl (meth)acrylate, butyl (meth)acrylate, 2-ethylhexyl (meth)acrylate, and combinations thereof;
and combinations thereof;
the mixture of ethylenically unsaturated monomers for latex polymer (I) optionally comprises ethylenically unsaturated monomers selected from
(vi) vinyl carboxylates;
(vii) monomers having at least two identical ethylenically unsaturated groups;
and combinations thereof.

9. The polymer latex composition of claim 6, wherein
the functional groups (I-a) are selected from groups having a carbon-carbon double bond and the functional groups (V-b) are selected from groups having carbon-carbon double bonds and thiol; or
the functional groups (I-a) are selected from carboxylic acid functional groups and the functional groups (V-b) are selected from epoxy, thiol, hydroxy, primary or secondary amino, isocyanato, oxazolino, aziridino, imino, carbodiimido, glycol groups, ester groups, and acetoxy; or
the functional groups (I-a) are selected from hydroxyl and the functional groups (V-b) are selected from alkoxysilyl, carboxylic acid functional groups; isocyanato, primary or secondary amino, aldehyde, boronic acid and ester groups; or
the functional groups (I-a) are selected from epoxy and the functional groups (V-b) are selected from carboxylic acid functional groups, hydroxyl and ester groups; or
the functional groups (I-a) are selected from acetoacetyl and the functional groups (V-b) are selected from groups having carbon-carbon double bonds, isocyanato, aldehyde, hydrazine, hydrazide, and primary or secondary amino; or
the functional groups (I-a) are selected from primary or secondary amino and the functional groups (V-b) are selected from carboxylic acid functional groups, epoxy, ester groups and dioxolanone groups; or
the functional groups (I-a) are selected from acetoxy and the functional groups (V-b) are selected from hydrazido and primary or secondary amino; or
the functional groups (I-a) are selected from isocyanato and the functional groups (V-b) are selected from carboxylic acid functional groups. hydroxyl, primary or secondary amino and thiol; or
the functional groups (I-a) are selected from alkoxysilyl and the functional groups (V-b) are selected hydroxyl and alkoxysilyl; or
the functional groups (I-a) are selected from alkoxy and the functional groups (V-b) are selected from ester groups; or
the functional groups (I-a) are selected from ester groups and the functional groups (V-b) are selected from hydroxyl, carboxylic acid groups and ester groups;
the functional groups (I-a) are selected from dioxolanone groups and the functional groups (V-b) are selected from primary or secondary amino;
the functional groups (I-a) are selected from halide functional groups and the functional groups (V-b) are selected from carboxylic acids;
the functional groups (I-a) are selected from thiol functional groups and the functional groups (V-b) are selected from carbon-carbon double bond, carboxylic acid functional groups, or isocyanato;
the functional groups (I-a) are selected from hydroxylamine and the functional groups (V-b) are selected from aldehyde;
the functional groups (I-a) are selected from oxazolino and the functional groups (V-b) are selected from carboxylic acid;
the functional groups (I-a) are selected from aziridino and the functional groups (V-b) are selected from carboxylic acid or hydroxyl;
the functional groups (I-a) are selected from imino and the functional groups (V-b) are selected from carboxylic acid;
the functional groups (I-a) are selected from carbodiimino and the functional groups (V-b) are selected from carboxylic acid;
the functional groups (I-a) are selected from glycol groups and the functional groups (V-b) are selected from carboxylic acid functional groups;
the functional groups (I-a) are selected from hydrazido and the functional groups (V-b) are selected from aldehyde;
the functional groups (I-a) are selected from aldehyde and the functional groups (V-b) are selected from hydroxyl, acetoacetyl, hydroxylamine, or hydrazido;
the functional groups (I-a) are selected from ketone and the functional groups (V-b) are selected from hydroxy.

10. A method for preparation of a polymer latex composition comprising:
(A) polymerizing in an emulsion polymerization process a composition comprising ethylenically unsaturated monomers for latex polymer (I) comprising at least one monomer resulting after polymerization in a functional group (I-a) to obtain a latex comprising particles of latex polymer (I) comprising functional groups (I-a); and
(B1) adding a silane compound (II) comprising at least two terminal silane functional groups (II-a) and a thermally reversible bond (II-b); or
(B2) adding a silane compound (III) comprising (III-a) one terminal silane functional group and (III-b) at least one additional functional group capable to form a thermally reversible bond (III-c) with the functional group (I-a) of the latex polymer (I),
(B1) adding a compound (II) comprising at least two terminal silane functional groups (II-a) and a thermally reversible bond (II-b); and
(C) optionally adding a compound (V) comprising one terminal silane functional groups (V-a) and at least one additional functional group (V-b) reactive with the functional groups (I-a) of the particles of the latex polymer (I), wherein the particles of latex polymer (I), and/or the compound (II), and/or the silane compound (III) and/or the compound (V) and/or their relative amounts are defined as in claim 1.

11. Use of the polymer latex composition according to claim 1 for the production of elastomeric articles or for coating or impregnating a substrate.

12. A compounded polymer latex composition suitable for the production of dip-molded articles comprising the polymer latex composition according to claim 1 and optionally adjuvants selected from sulfur vulcanization agents, accelerators for vulcanization, free-radical initiators, pigments and combinations thereof, and optionally comprising polyvalent cations and/or silica-based fillers.

13. A method for making dip-molded articles by
(a) providing a compounded latex composition according to claim 12;
(b) immersing a mold having the desired shape of the final article in a coagulant bath comprising a solution of a metal salt;
(c) removing the mold from the coagulant bath and optionally drying the mold;
(d) immersing the mold as treated in step b) and c) in the compounded latex composition of step a);
(e) coagulating a latex film on the surface of the mold;
(f) removing the latex-coated mold from the compounded latex composition and optionally immersing the latex-coated mold in a water bath;
(g) optionally drying the latex-coated mold;
(h) heat treating the latex-coated mold obtained from step e) or f) at a temperature of 40° C. to 180° C.; and/or exposing the latex-coated mold obtained from step e) or f) to UV radiation;
(i) removing the latex article from the mold.

14. A method for making elastomeric articles comprising:
(a) obtaining a continuous elastomeric film from the polymer latex composition according to claim 1;
(b) optionally heat treating the continuous elastomeric film and/or exposing the continuous elastomeric film to UV radiation;
(c) aligning two separate continuous elastomeric films;
(d) cutting or stamping the aligned continuous elastomeric films into a preselected shape to obtain two superposed layers of the elastomeric films in the preselected shape;
(e) joining together the superposed layers at least a preselected part of the periphery to form an elastomeric article
wherein the joining together is prefer-aby-performed by using thermal means.

15. An article made by using the polymer latex composition according to claim 1.
